(19) United States
(12) Patent Application Publication
(10) Pub. No.: US 2025/0076868 A1
(43) Pub. Date: Mar. 6, 2025

(54) BUILDING AUTOMATION SYSTEM WITH REMOTE DIAGNOSTICS AND CORRECTIVE ACTIONS FOR BUILDING EQUIPMENT FAULTS

(71) Applicant: Tyco Fire & Security GmbH, Neuhausen am Rheinfall (CH)

(72) Inventors: Deepak Tripathi, Delhi (IN); Atul Gupta, Gurgaon (IN); Abhishek Trivedi, Lucknow (IN); Rashmi Srivastava, Gorakhpur (IN); Keshav Tayal, MANSA (IN)

(73) Assignee: Tyco Fire & Security GmbH, Neuhausen am Rheinfall (CH)

(21) Appl. No.: 18/821,984

(22) Filed: Aug. 30, 2024

(30) Foreign Application Priority Data
Aug. 31, 2023 (IN) 202341058604

(51) Int. Cl. G05B 23/02; G05B 15/02

(52) U.S. Cl. CPC G05B 23/0275; G05B 15/02; G05B 23/0272

(57) ABSTRACT

A Building Automation System application, stored by one or more memory devices of a mobile device, can include instructions that, when executed by one or more processors, cause the one or more processors to establish a connection with a remote system of a building, obtain operational data includes an indication that a first device of building equipment has experienced an equipment fault, transmit one or more control signals to the remote system to address the equipment fault and to cause a change in operation of one or more devices of building equipment of the plurality of devices of building equipment, and obtain subsequent operational data that corresponds to operations of the first device of building equipment after transmission of the one or more control signals and indicates whether the equipment fault has been resolved.

### CROSS-REFERENCE TO RELATED PATENT APPLICATIONS

This application claims the benefit of and priority to Indian Provisional Patent Application No. 202341058604, filed Aug. 31, 2023, the entirety of which is incorporated by reference herein.

### BACKGROUND

The present disclosure relates generally to building management systems or building automation systems. The present disclosure relates more particularly to systems and methods for diagnosing and repairing faults in equipment of a building management system or building automation system.

A Building Management System (BMS) or Building Automation System (BAS) is, in general, a system of devices configured to control, monitor, and/or manage equipment in or around a building or building area. A BMS or BAS can include, for example, a HVAC system, a security system, a lighting system, a fire alerting system, any other system that is capable of managing building functions or devices, or any combination thereof. The terms BMS and BAS are used synonymously throughout the present disclosure.

A BAS may be controllable from a localized and/or an onsite premise. For example, a BAS may be controllable by an admin within a building. The admin may control the BAS using a computing device (e.g., a desktop computer). Controlling a BAS locally (e.g., within the building) may result in technicians and/or service providers being unable to diagnose and/or troubleshoot equipment faults without first traveling to the building and then joining the network. The need for the technician to first travel to the building, prior to diagnosing a fault, may impact a duration of equipment downtime (e.g., how long the equipment is experiencing a fault, how long the equipment is inoperable, how long the equipment is malfunctioning, etc.).

### SUMMARY

At least one embodiment relates to a mobile device. The mobile device can include one or more processors. The mobile device can include a memory. The memory can be coupled with the one or more processors. The memory can include a Building Automation System (BAS) application stored thereon. The BAS application can include instructions that, when executed by the one or more processors, cause the one or more processors to establish a connection with a remote system of a building. The remote system can be associated with a plurality of devices of building equipment of the building. The instructions can cause the one or more processors to obtain, via the connection with the remote system, operational data pertaining to the plurality of devices of building equipment. The operational data can include an indication that a first device of building equipment of the plurality of devices of building equipment has experienced an equipment fault. The instructions can cause the one or more processors to transmit, via the connection with the remote system, one or more control signals to the remote system to address the equipment fault. The one or more control signals can cause a change in operation of one or more devices of building equipment of the plurality of devices of building equipment. The instructions can cause the one or more processors to obtain, via the connection with the remote system, subsequent operational data. The subsequent operational data can correspond to operations of the first device of building equipment after transmission of the one or more control signals and indicates whether the equipment fault has been resolved.

In some embodiments, the instructions can cause the one or more processors to display, via a display of the mobile device, a Graphical User Interface (GUI) that includes graphical representation of the operational data.

In some embodiments, the instructions can cause the one or more processors to determine, responsive to receipt of the subsequent operational data, that the first device of building equipment is still experiencing the equipment fault. The instructions can cause the one or more processors to receive, via the GUI, a request to identify one or more second devices of building equipment of the plurality of devices of building equipment that service a first zone of the building. The first device of building equipment can also service the first zone of the building. The instructions can cause the one or more processors to establish, via the connection with the remote system, a connection with the one or more second devices of building equipment of the plurality of devices of building equipment.

In some embodiments, the instructions can cause the one or more processors to generate, responsive to receipt of an alert associated with the equipment fault, a graphical user interface (GUI) to include a graphical representation of the alert. The instructions can cause the one or more processors to receive, responsive to generation of the GUI, a selection of a selectable element of the GUI which triggers transmission of the one or more control signals to the remote system.

In some embodiments, the instructions can cause the one or more processors to update, responsive to the selection of the selectable element, the GUI to include information that indicates a cause of the equipment fault. The instructions can cause the one or more processors to receive, via the GUI, an input that includes resolution of the equipment fault, wherein the input includes information that identifies a performance of one or more actions that resolved the equipment fault.

In some embodiments, the one or more processors can establish the connection with the remote system via a gateway. The gateway can transmit one or more Application Programming Interface (API) messages to a network device to retrieve the operational data.

In some embodiments, the gateway can be in communication with a cloud system that stores first information associated with the building in a graph. The gateway can transmit one or more second API messages to the cloud system to ingest second information associated with the building into the graph.

In some embodiments, transmitting the one or more control signals to the remote system to address the equipment fault can include transmitting, via a network, a first Application Programming Interface (API) message to a cloud system. The first API message can include the one or more control signals. Transmitting the one or more control signals to the remote system to address the equipment fault can include causing, responsive to transmission of the first API message, the cloud system to transmit a second API message to the remote system. The second API message can include the one or more control signals. Receipt of the second API message can cause the remote system to transmit the one or more control signals to the first device of building equipment.

In some embodiments, the one or more processors can be in communication with a computing device. The computing device can (1) determine that the first device of building equipment has experienced the equipment fault and (2) receive an indication to generate a work order to address the equipment fault. The instructions can cause the one or more processors to receive, responsive to generation of the work order, the work order including an indication of the equipment fault. The instructions can cause the one or more processors to provide a graphical user interface (GUI). The GUI can include a graphical representation of the work order, and an indication of one or more actions to implement to address the equipment fault.

In some embodiments, the remote system can execute a fault detection or diagnostic (FDD) process to generate the indication that the first device of building equipment of the plurality of devices of building equipment has experienced the equipment fault. The remote system can re-execute, responsive to the change in operation of the one or more devices of building equipment of the plurality of devices of building equipment, the FDD process to determine whether the equipment fault has been addressed.

At least one embodiment relates to a system. The system can include one or more memory devices. The one or more memory devices can store instructions thereon. The instructions can, when executed by one or more processors, cause the one or more processors to detect an establishment of a connection between the system and a mobile device. The instructions can cause the one or more processors to transmit, responsive to detection of the establishment of the connection, to the mobile device via the connection, operational data pertaining to a plurality of devices of building equipment of a building. The operational data can include an indication that a first device of building equipment of the plurality of devices of building equipment has experienced an equipment fault. The instructions can cause the one or more processors to receive, from the mobile device via the connection, one or more control signals to address the equipment fault. The one or more control signals can cause a change in operation of one or more devices of building equipment of the plurality of devices of building equipment. The instructions can cause the one or more processors to transmit, to the mobile device via the connection, subsequent operational data that corresponds to operation of the first device of building equipment after execution of the one or more control signals and indicates whether the equipment fault has been resolved.

In some embodiments, transmission of the operational data can cause the mobile device to display a Graphical User Interface (GUI) that includes a graphical representation of the operational data.

In some embodiments, the instructions can cause the one or more processors to determine, responsive to transmission of the subsequent operational data, that the first device of building equipment is still experiencing the equipment fault. The instructions can cause the one or more processors to receive, from the mobile device via the connection, a request to identify one or more second devices of building equipment of the plurality of devices of building equipment that service a first zone of the building. The first device of the building equipment can also service the first zone of the building. The instructions can cause the one or more processors to establish a second connection with the one or more second devices of building equipment of the plurality of devices of building equipment.

In some embodiments, the connection with the mobile device can be provided via a gateway in communication with the mobile device and the one or more processors. The gateway can exchange information between the mobile device and the one or more processors via one or more Application Programming Interface (API) messages.

In some embodiments, the instructions can cause the one or more processors to receive the one or more control signals via an Application Programming Interface (API) message. The instructions can cause the one or more processors to transmit, responsive to receipt of the API message, the one or more control signals to the one or more devices of building equipment to cause the change in the operation of the one or more devices of building equipment.

In some embodiments, the instructions can cause the one or more processors to determine that the first device of building equipment has experienced the equipment fault. The instructions can cause the one or more processors to receive, responsive to determination that the first device of building has experienced the equipment fault, an indication to generate a work order to address the equipment fault. The instructions can cause the one or more processors to provide, responsive to generation of the work order, to the mobile device via the connection, the work order including an indication of the equipment fault.

In some embodiments, the instructions can cause the one or more processors to execute a fault detection or diagnostic (FDD) process to generate the indication that the first device of building equipment of the plurality of devices of building equipment has experienced the equipment fault. The instructions can cause the one or more processors to re-execute, responsive to the change in operation of the one or more devices of building equipment of the plurality of devices of building equipment, the FDD process to determine whether the equipment fault has been addressed.

At least one embodiment relates to a method. The method can include detecting, by one or more processing circuits of a system, an establishment of a connection between the system and a mobile device. The method can include transmitting, by the one or more processing circuits, responsive to detecting of the establishment of the connection, to the mobile device via the connection, operational data pertaining to a plurality of devices of building equipment of a building. The operational data can include an indication that a first device of building equipment of the plurality of devices of building equipment has experienced an equipment fault. The method can include receiving, by the one or more processing circuits, from the mobile device via the connection, one or more control signals to address the equipment fault. The one or more control signals can cause a change in operation of one or more devices of building equipment of the plurality of devices of building equipment. The method can include transmitting, by the one or more processing circuits, to the mobile device via the connection, subsequent operational data that corresponds to operation of the first device of building equipment after execution of the one or more control signals and indicates whether the equipment fault has been resolved.

In some embodiments, the method can include determining, by the one or more processing circuits, responsive to transmitting the subsequent operational data, that the first device of building equipment is still experiencing the equipment fault. The method can include receiving, by the one or more processing circuits, from the mobile device via the connection, a request to identify one or more second devices of building equipment of the plurality of devices of building equipment that service a first zone of the building. The first device of the building equipment can also service the first zone of the building. The method can include establishing, by the one or more processing circuits, a second connection with the one or more second devices of building equipment of the plurality of devices of building equipment.

In some embodiments, the method can include executing, by the one or more processing circuits, a fault detection or diagnostic (FDD) process to generate the indication that the first device of building equipment of the plurality of devices of building equipment has experienced the equipment fault. The method can include re-executing, by the one or more processing circuits, responsive to the change in operation of the one or more devices of building equipment of the plurality of devices of building equipment, the FDD process to determine whether the equipment fault has been addressed.

At least one embodiment relates to a system. The system can include one or more memory devices having instructions stored thereon. The instructions, when executed by one or more processors, cause the one or more processors to receive, via a gateway a communication with a plurality of pieces of building equipment of a building, operational data pertaining to the plurality of pieces of building equipment. The instructions can also cause the one or more processors to detect, using at least a portion of the operational data, an equipment fault for a first piece of building equipment of the plurality of pieces of building equipment. The instructions can also cause the one or more processors to provide, via a display, a Graphical User Interface (GUI) including a graphical indication of the equipment fault. The instructions can also cause the one or more processors to receive, via the GUI, an indication to generate a work order to address the equipment fault. The indication can identify a mobile device. The instructions can also cause the one or more processors to provide, responsive to generation of the work order, the work order to the mobile device. The work order can identify the first piece of building equipment, the equipment fault, and one or more portions of the operational data that pertain to the first piece of building equipment.

At least one embodiment relates to a system. The system can include a gateway. The gateway can be in communication with a plurality of pieces of building equipment of a building. The system can also include a first computing device. The first computing device can be in communication with the gateway. The first computing device can include one or more processors and memory. The memory can store instructions thereon. The instructions can, when executed by the one or more processors, cause the one or more processors to receive, via the gateway, operational data pertaining to the plurality of pieces of building equipment. The instructions can also cause the one or more processors to determine, using at least a portion of the operational data, that a first piece of building equipment has experienced an equipment fault, and receive, via a Graphical User Interface (GUI), an indication to generate a work order to address the equipment fault. The system can also include a second computing device. The second computing device can be in communication with the gateway and the first computing device. The second computing device can include one or more processors and memory storing instructions thereon. The instructions can, when executed by the one or more processors, cause the one or more processors to receive, responsive to generation of the work order, the work order including an indication of the equipment fault and provide, via a display of the second computing device, a second GUI comprising a graphical representation of the work order, and one or more selectable elements to implement one or more actions to address the equipment fault.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is drawing of a building equipped with a heating, ventilating, and air conditioning (HVAC) system, according to some embodiments.

FIG. 2 is a block diagram of a building management system (BMS) which can be used to monitor and control the building and HVAC system of FIG. 1, according to some embodiments.

FIG. 3 is a block diagram illustrating a system manager, zone coordinator, and zone controller of the BMS of FIG. 2 in greater detail, according to some embodiments.

FIG. 4 is a block diagram of a Building Automation System (BAS) which may be used to monitor and control building equipment in the building of FIG. 1, according to some embodiments.

FIG. 5 is a block diagram of a system for remote integration of devices into a BAS, according to some embodiments.

FIG. 6 is a flow diagram illustrating communication between one or more components of a system architecture, according to some embodiments.

FIG. 7A is a flow diagram of a process for providing remote integration of devices into a BAS, according to some embodiments.

FIG. 7B is a flow diagram of a process for providing remote integration of devices into a BAS, according to some embodiments.

FIG. 7C is a flow diagram of a process for providing remote integration of devices into a BAS, according to some embodiments.

FIG. 7D is a flow diagram of a process for providing remote integration of devices into a BAS, according to some embodiments.

FIG. 8 is a user interface including a ticket window, according to some embodiments.

FIG. 9 is a user interface including a create ticket window, according to some embodiments.

FIG. 10 is a user interface including a ticket summary window, according to some embodiments.

FIG. 11 is a user interface including a launch screen for a mobile application, according to some embodiments.

FIG. 12 is a user interface including a ticket screen for a mobile application, according to some embodiments.

FIG. 13 is a user interface including a ticket view screen for a mobile application, according to some embodiments.

FIG. 14 is a user interface including a ticket detail screen for a mobile application, according to some embodiments.

FIG. 15 is a user interface including information pertaining to one or more alarms for a piece of building equipment, according to some embodiments.

FIG. 16 is a user interface including a resolution screen for a mobile application, according to some embodiments.

FIG. 17 is a user interface including a pop-up window for a mobile application, according to some embodiments.

FIG. 18 is a user interface including a gateway screen for a mobile application, according to some embodiments.

FIG. 19 is a user interface including a signature screen for a mobile application, according to some embodiments.

FIG. 20 is a user interface including a controller screen for a mobile application, according to some embodiments.

FIG. 21 is a user interface including a pop-up window for a mobile application, according to some embodiments.

FIG. 22 is a user interface including a trend chart, according to some embodiments.

FIG. 23 is a user interface including a status trend chart, according to some embodiments.

FIG. 24 is a flow diagram of a process for addressing faults in building equipment, according to some embodiments.

FIG. 25 is a flow diagram of a process for addressing faults in building equipment, according to some embodiments.

### DETAILED DESCRIPTION

### Overview

Referring generally to the FIGURES, a building management system (BMS) with automatic equipment discovery and equipment model distribution is shown, according to some embodiments. A BMS is, in general, a system of devices configured to control, monitor, and manage equipment in or around a building or building area. A BMS can include a heating, ventilation, or air conditioning (HVAC) system, a security system, a lighting system, a fire alerting system, another system that is capable of managing building functions or devices, or any combination thereof. BMS devices may be installed in any environment (e.g., an indoor area or an outdoor area) and the environment may include any number of buildings, spaces, zones, rooms, or areas. A BMS may include VERASYS® building controllers or other devices sold by Johnson Controls, Inc., as well as building devices and components from other sources.

A Building Automation System (BAS) is, in general, a system of devices configured to control, monitor, and/or manage equipment in or around a building or building area. A BAS can include, for example, a HVAC system, a security system, a lighting system, a fire alerting system, any other system that is capable of managing building functions or devices, or any combination thereof.

In brief overview, the BMS described herein provides a system architecture that facilitates automatic equipment discovery and equipment model distribution. Equipment discovery can occur on multiple levels of the BMS across multiple different communications busses (e.g., a system bus, zone buses, a sensor/actuator bus, etc.) and across multiple different communications protocols. In some embodiments, equipment discovery is accomplished using active node tables, which provide status information for devices connected to each communications bus. For example, each communications bus can be monitored for new devices by monitoring the corresponding active node table for new nodes. When a new device is detected, the BMS can begin interacting with the new device (e.g., sending control signals, using data from the device) without user interaction.

Some devices in the BMS present themselves to the network using equipment models. An equipment model defines equipment object attributes, view definitions, schedules, trends, and the associated BACnet value objects (e.g., analog value, binary value, multistate value, etc.) that are used for integration with other systems. Some devices in the BMS store their own equipment models. Other devices in the BMS have equipment models stored externally (e.g., within other devices). For example, a zone coordinator can store the equipment model for a bypass damper. In some embodiments, the zone coordinator automatically creates the equipment model for the bypass damper and/or other devices on the zone bus. Other zone coordinators can also create equipment models for devices connected to their zone busses. The equipment model for a device can be created automatically based on the types of data points exposed by the device on the zone bus, device type, and/or other device attributes.

BMSs and BASs may be controllable from a localized and/or an onsite premise. For example, a BMS may be controllable by an admin within a building. The admin may control the BMS using a computing device (e.g., a desktop computer). Controlling BMSs and/or BASs locally (e.g., within the building) may result in technicians and/or service providers being unable to diagnose and/or troubleshoot equipment faults without first traveling to the building and then joining the network. The need for the technician to first travel to the building, prior to diagnosing a fault, may impact a duration of equipment downtime (e.g., how long the equipment is experiencing a fault, how long the equipment is inoperable, how long the equipment is malfunctioning, etc.).

Some technical solutions described herein include a system architecture where a remote device (e.g., a device that is external to and/or located remote to the building) communicates with equipment of the building. The remote device may receive operational data pertaining to the equipment and the remote device may diagnose and/or troubleshoot faults. The remote device may communicate with a gateway (located within and/or proximate to the building) to receive and/or transmit signals to various components of the building. For example, the remote device, via the gateway, may transmit a signal to a controller that controls an Air Handler Unit (AHU) of the building. As another example, the remote device may receive, via the gateway, zone conditions from an HVAC controller.

The remote integration (e.g., connecting the remote device to a BMS and/or a BAS of a building) of the remote device with various components of a building may result in quicker response times and/or shorter equipment downtime. For example, a technician may be able to diagnose an equipment fault indicating that a given piece of equipment failed. To continue this example, the technician may bring a new piece of equipment to replace the failed piece of equipment. Without diagnosing (prior to being present at the building) the given piece of equipment, the technician may need to first go to the building and then perform a diagnosis once present at the building. The technician traveling to the building, prior to performing a diagnosis, may result in prolonged details (e.g., building equipment downtime and/or building equipment inoperability).

### Building and HVAC System

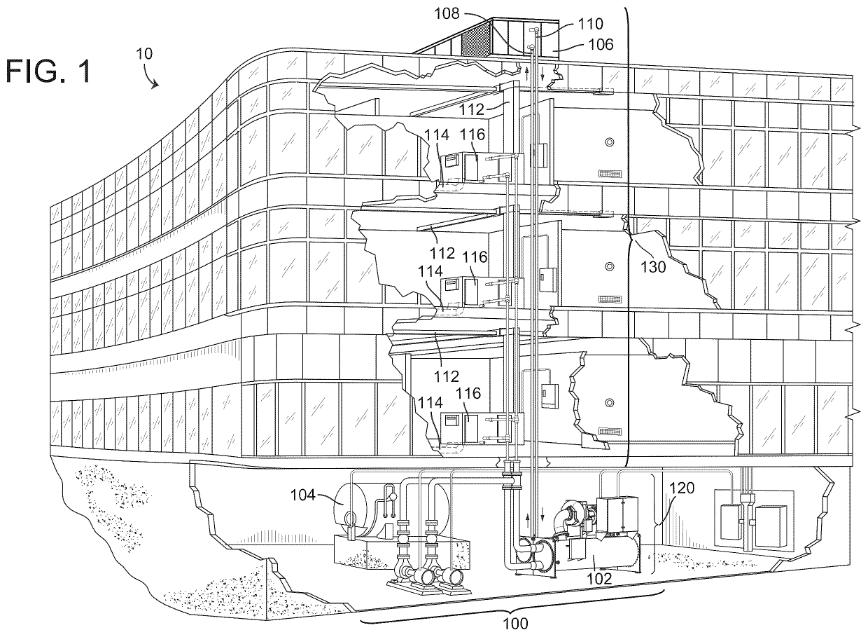

Referring now to FIG. 1, an exemplary building and HVAC system in which the systems and methods of the present invention can be implemented are shown, according to an exemplary embodiment. In FIG. 1, a perspective view of a building 10 is shown. Building 10 is served by a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone.

### Building Management System

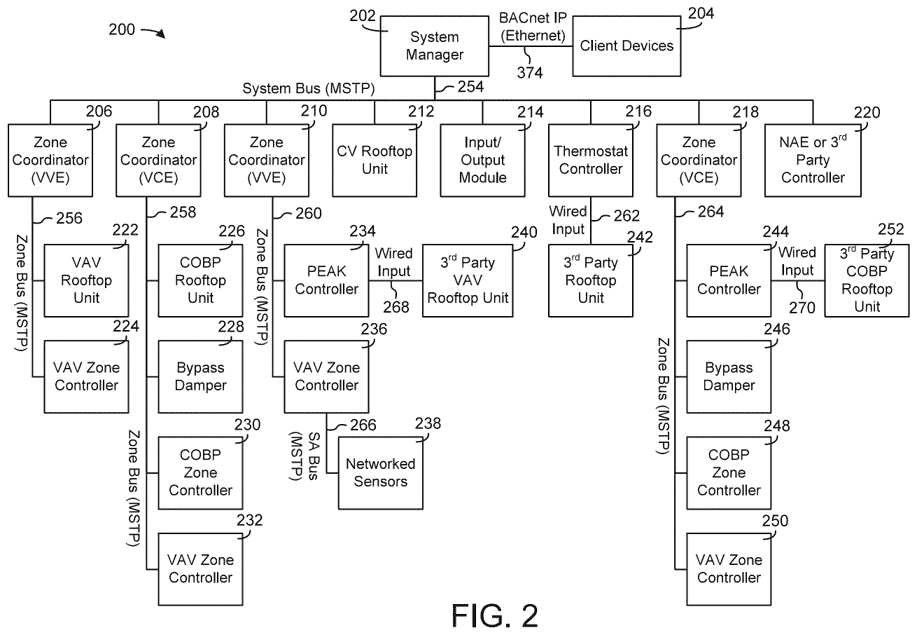

Referring now to FIG. 2, a block diagram of a building management system (BMS) 200 is shown, according to an exemplary embodiment. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof. BMS 200 can be used to monitor and control the devices of HVAC system 100 and/or airside system 130 (e.g., HVAC equipment) as well as other types of BMS devices (e.g., lighting equipment, security equipment, etc.).

In brief overview, BMS 200 provides a system architecture that facilitates automatic equipment discovery and equipment model distribution. Equipment discovery can occur on multiple levels of BMS 200 across multiple different communications busses (e.g., a system bus 254, zone buses 256-260 and 264, sensor/actuator bus 266, etc.) and across multiple different communications protocols. In some embodiments, equipment discovery is accomplished using active node tables, which provide status information for devices connected to each communications bus. For example, each communications bus can be monitored for new devices by monitoring the corresponding active node table for new nodes. When a new device is detected, BMS 200 can begin interacting with the new device (e.g., sending control signals, using data from the device) without user interaction.

Some devices in BMS 200 present themselves to the network using equipment models. An equipment model defines equipment object attributes, view definitions, schedules, trends, and the associated BACnet value objects (e.g., analog value, binary value, multistate value, etc.) that are used for integration with other systems. An equipment model for a device can include a collection of point objects that provide information about the device (e.g., device name, network address, model number, device type, etc.) and store present values of variables or parameters used by the device. For example, the equipment model can include point objects (e.g., standard BACnet point objects) that store the values of input variables accepted by the device (e.g., setpoint, control parameters, etc.), output variables provided by the device (e.g., temperature measurement, feedback signal, etc.), configuration parameters used by the device (e.g., operating mode, actuator stroke length, damper position, tuning parameters, etc.). The point objects in the equipment model can be mapped to variables or parameters stored within the device to expose those variables or parameters to external systems or devices.

Some devices in BMS 200 store their own equipment models. Other devices in BMS 200 have equipment models stored externally (e.g., within other devices). For example, a zone coordinator 208 can store the equipment model for a bypass damper 228. In some embodiments, zone coordinator 208 automatically creates the equipment model for bypass damper 228 or other devices on zone bus 258. Other zone coordinators can also create equipment models for devices connected to their zone busses. The equipment model for a device can be created automatically based on the types of data points exposed by the device on the zone bus, device type, and/or other device attributes. Several examples of automatic equipment discovery and equipment model distribution are discussed in greater detail below.

Still referring to FIG. 2, BMS 200 is shown to include a system manager 202; several zone coordinators 206, 208, 210 and 218; and several zone controllers 224, 230, 232, 236, 248, and 250. System manager 202 can communicate with client devices 204 (e.g., user devices, desktop computers, laptop computers, mobile devices, etc.) via a data communications link 374 (e.g., BACnet IP, Ethernet, wired or wireless communications, etc.). System manager 202 can provide a user interface to client devices 204 via data communications link 374. The user interface may allow users to monitor and/or control BMS 200 via client devices 204.

In some embodiments, system manager 202 is connected with zone coordinators 206-210 and 218 via a system bus 254. System bus 254 can include any of a variety of communications hardware (e.g., wire, optical fiber, terminals, etc.) configured to facilitate communications between system manager and other devices connected to system bus 254. Throughout this disclosure, the devices connected to system bus 254 are referred to as system bus devices. System manager 202 can be configured to communicate with zone coordinators 206-210 and 218 via system bus 254 using a master-slave token passing (MSTP) protocol or any other communications protocol. System bus 254 can also connect system manager 202 with other devices such as a constant volume (CV) rooftop unit (RTU) 212, an input/output module (IOM) 214, a thermostat controller 216 (e.g., a TEC2000 series thermostat controller), and a network automation engine (NAE) or third-party controller 220. RTU 212 can be configured to communicate directly with system manager 202 and can be connected directly to system bus 254. Other RTUs can communicate with system manager 202 via an intermediate device. For example, a wired input 262 can connect a third-party RTU 240 to thermostat controller 216, which connects to system bus 254.

System manager 202 can provide a user interface for any device containing an equipment model. Devices such as zone coordinators 206-210 and 218 and thermostat controller 216 can provide their equipment models to system manager 202 via system bus 254. In some embodiments, system manager 202 automatically creates equipment models for connected devices that do not contain an equipment model (e.g., IOM 214, third party controller 220, etc.). For example, system manager 202 can create an equipment model for any device that responds to a device tree request. The equipment models created by system manager 202 can be stored within system manager 202. System manager 202 can then provide a user interface for devices that do not contain their own equipment models using the equipment models created by system manager 202. In some embodiments, system manager 202 stores a view definition for each type of equipment connected via system bus 254 and uses the stored view definition to generate a user interface for the equipment.

Each zone coordinator 206-210 and 218 can be connected with one or more of zone controllers 224, 230-232, 236, and 248-250 via zone buses 256, 258, 260, and 264. Zone busses 256, 258, 260, and 264 can include any of a variety of communications hardware (e.g., wire, optical fiber, terminals, etc.) configured to facilitate communications between a zone coordinator and other devices connected to the corresponding zone bus. Throughout this disclosure, the devices connected to zone busses 256, 258, 260, and 264 are referred to as zone bus devices. Zone coordinators 206-210 and 218 can communicate with zone controllers 224, 230-232, 236, and 248-250 via zone busses 256-260 and 264 using a MSTP protocol or any other communications protocol. Zone busses 256-260 and 264 can also connect zone coordinators 206-210 and 218 with other types of devices such as variable air volume (VAV) RTUs 222 and 240, changeover bypass (COBP) RTUs 226 and 252, bypass dampers 228 and 246, and PEAK controllers 234.

Zone coordinators 206-210 and 218 can be configured to monitor and command various zoning systems. In some embodiments, each zone coordinator 206-210 and 218 monitors and commands a separate zoning system and is connected to the zoning system via a separate zone bus. For example, zone coordinator 206 can be connected to VAV RTU 222 and zone controller 224 via zone bus 256. Zone coordinator 208 can be connected to COBP RTU 226, bypass damper 228, COBP zone controller 230, and VAV zone controller 232 via zone bus 258. Zone coordinator 210 can be connected to PEAK controller 234 and VAV zone controller 236 via zone bus 260. Zone coordinator 218 can be connected to PEAK controller 224, bypass damper 246, COBP zone controller 248, and VAV zone controller 250 via zone bus 264.

A single model of zone coordinator 206-210 and 218 can be configured to handle multiple different types of zoning systems (e.g., a VAV zoning system, a COBP zoning system, etc.). Each zoning system can include a RTU, one or more zone controllers, and/or a bypass damper. For example, zone coordinators 206 and 210 are shown as Verasys VAV engines (VVEs) connected to VAV RTUs 222 and 240, respectively. Zone coordinator 206 is connected directly to VAV RTU 222 via zone bus 256, whereas zone coordinator 210 is connected to a third-party VAV RTU 240 via a wired input 268 provided to PEAK controller 234. Zone coordinators 208 and 218 are shown as Verasys COBP engines (VCEs) connected to COBP RTUs 226 and 252, respectively. Zone coordinator 208 is connected directly to COBP RTU 226 via zone bus 258, whereas zone coordinator 218 is connected to a third-party COBP RTU 252 via a wired input 270 provided to PEAK controller 234.

Zone controllers 224, 230-232, 236, and 248-250 can communicate with individual BMS devices (e.g., sensors, actuators, etc.) via sensor/actuator (SA) busses. For example, VAV zone controller 236 is shown connected to networked sensors 238 via SA bus 266. Networked sensors 238 can include, for example, temperature sensors, humidity sensors, pressure sensors, lighting sensors, security sensors, or any other type of device configured to measure and/or provide an input to zone controller 236. Zone controller 236 can communicate with networked sensors 238 using a MSTP protocol or any other communications protocol. Although only one SA bus 266 is shown in FIG. 2, it should be understood that each zone controller 224, 230-232, 236, and 248-250 can be connected to a different SA bus. Each SA bus can connect a zone controller with various sensors (e.g., temperature sensors, humidity sensors, pressure sensors, light sensors, occupancy sensors, etc.), actuators (e.g., damper actuators, valve actuators, etc.) and/or other types of controllable equipment (e.g., chillers, heaters, fans, pumps, etc.).

Each zone controller 224, 230-232, 236, and 248-250 can be configured to monitor and control a different building zone. Zone controllers 224, 230-232, 236, and 248-250 can use the inputs and outputs provided via their SA busses to monitor and control various building zones. For example, a zone controller 236 can use a temperature input received from networked sensors 238 via SA bus 266 (e.g., a measured temperature of a building zone) as feedback in a temperature control algorithm. Zone controllers 224, 230-232, 236, and 248-250 can use various types of control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control a variable state or condition (e.g., temperature, humidity, airflow, lighting, etc.) in or around building 10.

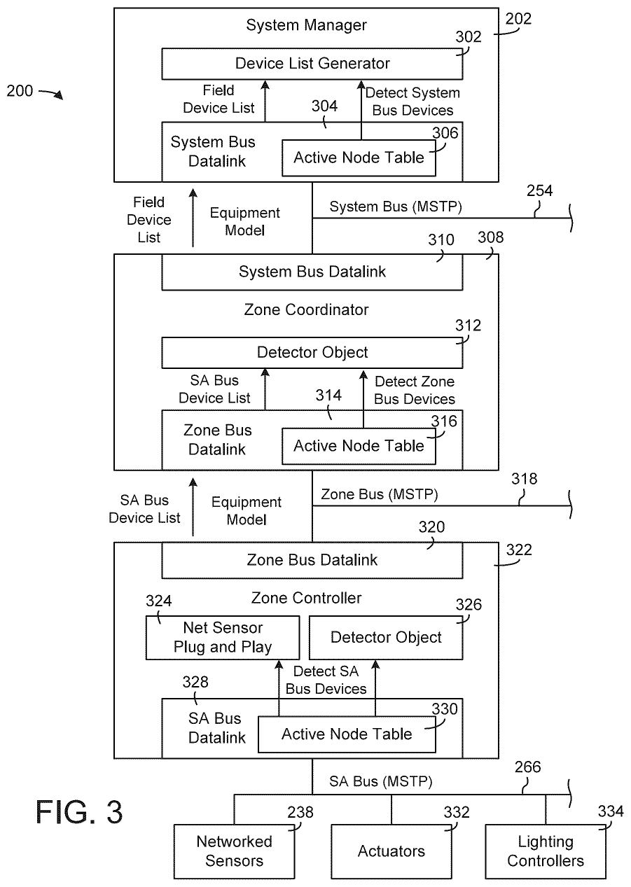

Referring now to FIG. 3, a block diagram illustrating a portion of BMS 200 in greater detail is shown, according to an exemplary embodiment. BMS 200 is shown to include system manager 202, a zone coordinator 308, and a zone controller 322. Zone coordinator 308 can be any of zone coordinators 206-210 or 218. Zone controller 322 can be any of zone controllers 224, 230, 232, 236, 248, or 250. Zone coordinator 308 can be connected with system manager via system bus 254. For example, system bus 254 is shown connecting a first system bus datalink 304 within system manager 202 with a second system bus datalink 310 within zone coordinator 308. Zone coordinator 308 can be connected with zone controller 322 via a zone bus 318. For example, zone bus 318 is shown connecting a first zone bus datalink 314 within zone coordinator 308 with a second zone bus datalink 320 within zone controller 322. Zone bus 318 can be any of zone busses 256-260 or 264. Zone controller 322 is connected with networked sensors 238 and actuators 332 via a SA bus 266.

BMS 200 can automatically discover new equipment connected to any of system bus 254, zone bus 318, and SA bus 266. Advantageously, the equipment discovery can occur automatically (e.g., without user action) without requiring the equipment to be placed in discovery mode and without sending a discovery command to the equipment. In some embodiments, the automatic equipment discovery is based on active node tables for system bus 254, zone bus 318, and SA bus 266. Each active node table can provide status information for the devices communicating on a particular bus. For example, the active node table 306 for system bus 254 can indicate which MSTP devices are participating in the token ring used to exchange information via system bus 254. Active node table 306 can identify the devices communicating on system bus 254 by MAC address or other device identifier. Devices that do not participate in the token ring (e.g., MSTP slave devices) can be automatically discovered using a net sensor plug and play (described in greater detail below).

The active node table for each communications bus can be stored within one or more devices connected to the bus. For example, active node table 306 can be stored within system manager 202. In some embodiments, active node table 306 is part of a system bus datalink 304 (e.g., a MSTP datalink) used by system manager 202 to communicate via system bus 254. System manager 202 can subscribe to changes in value of active node table 306 and can receive a notification (e.g., from system bus datalink 304) when a change in active node table 306. In response to a notification that a change in active node table 306 has occurred, system manager 202 can read active node table 306 to detect and identify the devices connected to system bus 254.

In some embodiments, a device list generator 302 within system manager 202 generates a list of the devices connected to system bus 254 (i.e., a device list) based on active node table 306 and stores the device list within system manager 202. The device list generated by system manager 202 can include information about each device connected to system bus 254 (e.g., device type, device model, device ID, MAC address, device attributes, etc.). When a new device is detected on system bus 254, system manager 202 can automatically retrieve the equipment model from the device if the device stores its own equipment model. If the device does not store its own equipment model, system manager 202 can retrieve a list of point values provided by the device. System manager 202 can then use the equipment model and/or list of point values to present information about the connected system bus devices to a user.

The active node tables for each zone bus can be stored within the zone coordinator connected to the zone bus. For example, the active node table 316 for zone bus 318 can be stored within zone coordinator 308. In some embodiments, active node table 316 is part of a zone bus datalink 314 (e.g., a MSTP datalink) used by the zone coordinator 308 to communicate via zone bus 318. Zone coordinator 308 can subscribe to changes in value of active node table 316 and can receive a notification (e.g., from zone bus datalink 314) when a change in active node table 316 occurs. In response to a notification that a change to active node table 316 has occurred, zone coordinator 308 can read active node table 316 to identify the devices connected to zone bus 318.

In some embodiments, a detector object 312 of zone coordinator 308 generates a list of the devices communicating on zone bus 318 (i.e., a device list) based on active node table 316 and stores the device list within zone coordinator 308. Each zone coordinator in BMS 200 can generate a list of devices on the connected zone bus. The device list generated by each zone coordinator 308 can include information about each device connected to zone bus 318 (e.g., device type, device model, device ID, MAC address, device attributes, etc.). When a new device is detected on zone bus 318, the connected zone coordinator 308 can automatically retrieve the equipment model from the device if the device stores its own equipment model. If the device does not store its own equipment model, the connected zone coordinator 308 can retrieve a list of point values provided by the device.

Zone coordinator 308 can incorporate the new zone bus device into the zoning logic and can inform system manager 202 that a new zone bus device has been added. For example, zone coordinator 308 is shown providing a field device list to system manager 202. The field device list can include a list of devices connected to zone bus 318 and/or SA bus 266. System manager 202 can use the field device list and the list of system bus devices to generate a device trec including all of the devices in BMS 200. In some embodiments, zone coordinator 308 provides an equipment model for a connected zone bus device to system manager 202. System manager 202 can then use the equipment model and/or list of point values for the new zone bus device to present information about the new zone bus device to a user.

In some embodiments, the device list generated by each zone coordinator 308 indicates whether system manager 202 should communicate directly with the listed zone bus device (e.g., VAV RTU 222, VAV zone controller 224, etc.) or whether system manager 202 should communicate with the intermediate zone coordinator 308 on behalf of the zone bus device. In some embodiments, system manager 202 communicates directly with zone bus devices that provide their own equipment models, but communicates with the intermediate zone coordinator 308 for zone bus devices that do not provide their own equipment model. As discussed above, the equipment models for zone bus devices that do not provide their own equipment model can be generated by the connected zone coordinator 308 and stored within the zone coordinator 308. Accordingly, system manager 202 may communicate directly with the device that stores the equipment model for a connected zone bus device (i.e., the zone bus device itself or the connected zone coordinator 308).

The active node table 330 for SA bus 266 can be stored within zone controller 322. In some embodiments, active node table 330 is part of the SA bus datalink 328 (e.g., a MSTP datalink) used by zone controller 322 to communicate via SA bus 266. Zone controller 322 can subscribe to changes in value of the active node table 330 and can receive a notification (e.g., from SA bus datalink 328) when a change in active node table 330 occurs. In response to a notification that a change to active node table 330 has occurred, zone controller 322 can read active node table 330 to identify some or all of the devices connected to SA bus 266. In some embodiments, active node table 330 identifies only the SA bus devices participating in the token passing ring via SA bus 266 (e.g., MSTP master devices). Zone controller 322 can include an additional net sensor plug and play (NsPnP) 324 configured to detect SA bus devices that do not participate in the token passing ring (e.g., MSTP slave devices).

In some embodiments, NsPnP 324 is configured to actively search for devices connected to SA bus 266 (e.g., networked sensors 238, actuators 332, lighting controllers 334, etc.). For example, NsPnP 324 can send a “ping” to a preconfigured list of MSTP slave MAC addresses. For each SA bus device that is discovered (i.e., responds to the ping), NsPnP 324 can dynamically bring it online. NsPnP 324 can bring a device online by creating and storing an instance of a SA bus device object representing the discovered SA bus device. NsPnP 324 can automatically populate the SA bus device object with all child point objects needed to collect and store point data (e.g., sensor data) from the newly discovered SA bus device. In some embodiments, NsPnP 324 automatically maps the child point objects of the SA bus device object to attributes of the equipment model for zone controller 322. Accordingly, the data points provided by the SA bus devices can be exposed to zone coordinator 308 and other devices in BMS 200 as attributes of the equipment model for zone controller 322.

In some embodiments, a detector object 326 of zone controller 322 generates a list of the devices connected to SA bus 266 (i.e., a device list) based on active node table 330 and stores the device list within zone controller 322. NsPnP 324 can update the device list to include any SA bus devices discovered by NsPnP 324. The device list generated by zone controller 322 can include information about each device connected to SA bus 266 (e.g., device type, device model, device ID, MAC address, device attributes, etc.). When a new device is detected on SA bus 266, zone controller 322 can automatically retrieve the equipment model from the device if the device stores its own equipment model. If the device does not store its own equipment model, zone controller 322 can retrieve a list of point values provided by the device.

Zone controller 322 can incorporate the new SA bus device into the zone control logic and can inform zone coordinator 308 that a new SA bus device has been added. Zone coordinator 308 can then inform system manager 202 that a new SA bus device has been added. For example, zone controller 322 is shown providing a SA device list to zone coordinator 308. The SA device list can include a list of devices connected to SA bus 266. Zone coordinator 308 can use the SA device list and the detected zone bus devices to generate the field device list provided to system manager 202. In some embodiments, zone controller 322 provides an equipment model for a connected SA bus device to zone coordinator 308, which can be forwarded to system manager 202. System manager 202 can then use the equipment model and/or list of point values for the new SA bus device to present information about the new SA bus device to a user. In some embodiments, data points provided by the SA bus device are shown as attributes of the zone controller 322 to which the SA bus device is connected.

Additional features and advantages of BMS 200, system manager 202, zone coordinator 308, and zone controller 322 are described in detail in U.S. patent application Ser. No. 15/179,894 filed Jun. 10, 2016, the entire disclosure of which is incorporated by reference herein.

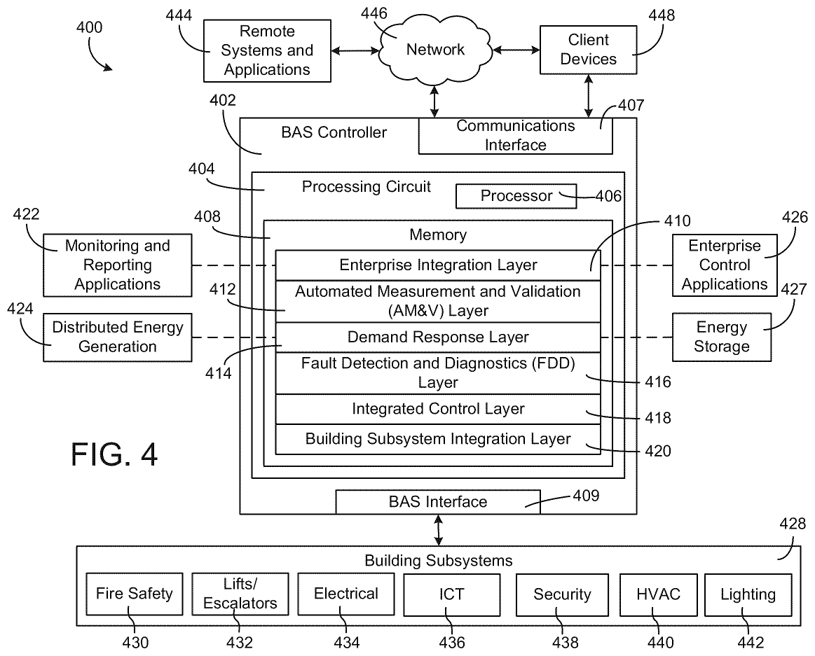

Referring now to FIG. 4, a block diagram of a building automation system (BAS) 400 is shown, according to an exemplary embodiment. BAS 400 may be implemented in building 10 to automatically monitor and control various building functions. BAS 400 is shown to include BAS controller 402 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 may include at least one of the various building systems and/or building subsystems described herein. For example, the building subsystems 428 may include airside system 130.

Each of building subsystems 428 may include any number of devices, controllers, and connections for completing its individual functions and control activities. HVAC subsystem 440 may include many of the same components as HVAC system 100. For example, HVAC subsystem 440 may include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 may include any number of light fixtures, ballasts, lighting sensors, dimmers, or other devices configured to controllably adjust the amount of light provided to a building space. Security subsystem 438 may include occupancy sensors, video surveillance cameras, digital video recorders, video processing servers, intrusion detection devices, access control devices and servers, or other security-related devices.

Still referring to FIG. 4, BAS controller 402 is shown to include a communications interface 407 and a BAS interface 409. Interface 407 may facilitate communications between BAS controller 402 and external applications (e.g., monitoring and reporting applications 422, enterprise control applications 426, remote systems and applications 444, applications residing on client devices 448, etc.) for allowing user control, monitoring, and adjustment to BAS controller 402 and/or subsystems 428. Interface 407 may also facilitate communications between BAS controller 402 and client devices 448. BAS interface 409 may facilitate communications between BAS controller 402 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 may be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 may include cellular or mobile phone communications transceivers. In one embodiment, communications interface 407 is a power line communications interface and BAS interface 409 is an Ethernet interface. In other embodiments, both communications interface 407 and BAS interface 409 are Ethernet interfaces or are the same Ethernet interface.

Still referring to FIG. 4, BAS controller 402 is shown to include a processing circuit 404 including a processor 406 and memory 408. Processing circuit 404 may be communicably connected to BAS interface 409 and/or communications interface 407 such that processing circuit 404 and the various components thereof can send and receive data via interfaces 407, 409. Processor 406 can be implemented as a general-purpose processor, an application specific integrated circuit (ASIC), one or more field programmable gate arrays (FPGAs), a group of processing components, or other suitable electronic processing components.

Memory 408 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 408 may be or include volatile memory or non-volatile memory. Memory 408 may include database components, object code components, script components, or any other type of information structure for supporting the various activities and information structures described in the present application. According to an exemplary embodiment, memory 408 is communicably connected to processor 406 via processing circuit 404 and includes computer code for executing (e.g., by processing circuit 404 and/or processor 406) one or more processes described herein.

In some embodiments, BAS controller 402 is implemented within a single computer (e.g., one server, one housing, etc.). In various other embodiments, BAS controller 402 may be distributed across multiple servers or computers (e.g., that can exist in distributed locations). Further, while FIG. 4 shows applications 422 and 426 as existing outside of BAS controller 402, in some embodiments, applications 422 and 426 may be hosted within BAS controller 402 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 may be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BAS 400.

Enterprise integration layer 410 may be configured to serve clients or local applications with information and services to support a variety of enterprise-level applications. For example, enterprise control applications 426 may be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BAS controller 402. In yet other embodiments, enterprise control applications 426 can work with layers 410-420 to optimize building performance (e.g., efficiency, energy use, comfort, or safety) based on inputs received at interface 407 and/or BAS interface 409.

Building subsystem integration layer 420 may be configured to manage communications between BAS controller 402 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 may be configured to optimize resource usage (e.g., electricity use, natural gas use, water use, etc.) and/or the monetary cost of such resource usage in response to satisfy the demand of building 10. The optimization may be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BAS controller 402 (e.g., building subsystem integration layer 420, integrated control layer 418, etc.). The inputs received from other layers may include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to an exemplary embodiment, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models may include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions may be edited or adjusted by a user (e.g., via a graphical user interface) so that the control actions initiated in response to demand inputs may be tailored for the user's application, desired comfort level, particular building equipment, or based on other concerns. For example, the demand response policy definitions can specify which equipment may be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 may be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In an exemplary embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 may be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 may be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 may be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 may be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 may be configured to provide calculated inputs (e.g., aggregations) to these higher levels based on outputs from more than one building subsystem.

Automated measurement and validation (AM&V) layer 412 may be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 may be based on building system energy models and/or equipment models for individual BAS devices or subsystems. For example, AM&V layer 412 may compare a model-predicted output with an actual output from building subsystems 428 to determine an accuracy of the model.

Fault detection and diagnostics (FDD) layer 416 may be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults may include providing an alert message to a user, a maintenance scheduling system, or a control algorithm configured to attempt to repair the fault or to work-around the fault.

FDD layer 416 may be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to an exemplary embodiment, FDD layer 416 (or a policy executed by an integrated control engine or business rules engine) may shut-down systems or direct control activities around faulty devices or systems to reduce energy waste, extend equipment life, or assure proper control response.

FDD layer 416 may be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BAS 400 and the various components thereof. The data generated by building subsystems 428 may include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Remote Diagnostics and Corrective Actions for Building Equipment Faults

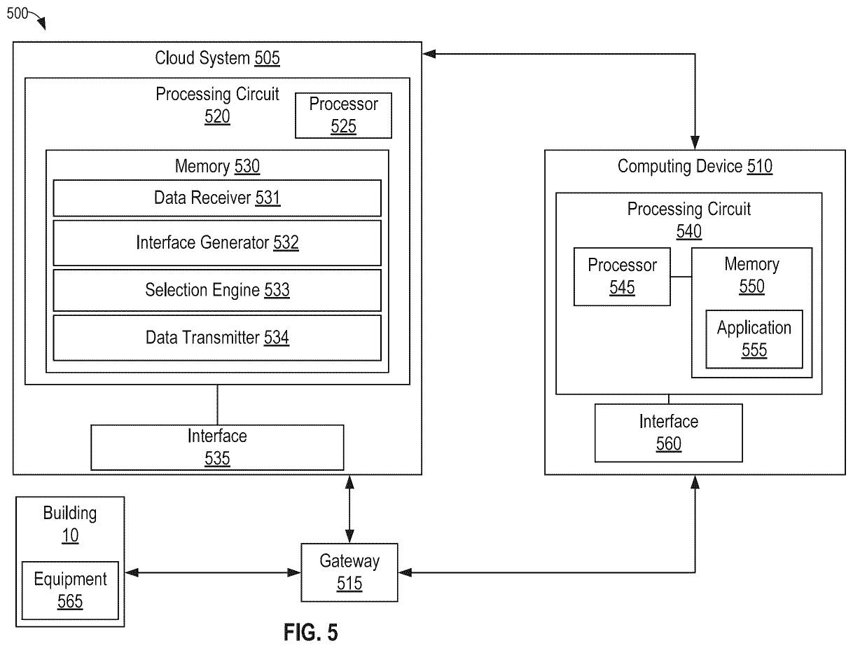

FIG. 5 is a block diagram of a system 500, according to some embodiments. The system 500 may include and/or be implemented as at least one of the various systems described herein. For example, the system 500 may be implemented as the BAS 400. In some embodiments, the system 500 may include at least one of the various systems and/or components described herein. For example, the system 500 may include the network 446. In some embodiments, systems, components, and/or devices of the system 500 may be added, removed, integrated, combined, separated, rearranged, relocated, and/or replaced. For example, a device of the system 500 that may be shown to include two components may be modified such that the two components are combined into a single component. As another example, a component that is shown to be included in a first device may also be added to a second device. Each system or device in the system 500 may include one or more processors, memories, network interfaces, and user interfaces. The memories may store programming logic that, when executed by the processors, controls the operation of a corresponding computing system or device. The memories may also store data in databases.

In some embodiments, the system 500 may include at least one cloud system 505, at least one computing device 510, at least one gateway 515, and the building 10. In some embodiments, systems, devices, and/or components of the system 500 may be in communication with one another. For example, a first device may transmit signals to a second device. In some embodiments, the communication may include wireless communication. For example, the communication may include communication via a Wireless Local Area network (WLAN). In some embodiments, the communication may include wired communication. For example, the communication may include communication via wires and/or cables.

The cloud system 505 may include at least one of servers, remote computing systems, a cloud-based system, remote databases, and/or other possible cloud computing systems. In some embodiments, the cloud system 505 may include similar components to at least one the various systems and/or devices described herein. For example, the cloud system 505 may include the BAS controller 402. In some embodiments, the cloud system 505 may perform operations similar to that of at least one component and/or device described herein. For example, the cloud system 505 may perform operations similar to that of monitoring and reporting applications 422.

In some embodiments, the cloud system 505 may include at least one processing circuit 520 and at least one interface 535. In some embodiments, the processing circuit 520 may perform at least one of the various operations described herein. In some embodiments, the processing circuit 520 may include hardware and/or circuitry similar to at least one of devices and/or components described herein. The interface 535 may include at least one of a Human-Machine Interface (HMI), a communication interface, a network interface, a transmitter, an antenna, a receiver, and/or a transceiver. In some embodiments, the interface 535 may include at least one display device (e.g., a screen, a monitory, a Liquid Crystal Display (LCD) screen, a touch screen, an Input/Output (I/O) device, and/or other possible devices. In some embodiments, the interface 535 may communicate with at least one of the devices and/or components of the system 500. For example, the interface 535 may communicate with the gateway 515. In some embodiments, the processing circuit 520 may perform operations similar to that of the interface 535.

In some embodiments, the processing circuit 520 may include at least one processor 525 and at least one memory 530. In some embodiments, the processors 525 may include at least one of the various processors, hardware, and/or circuitry described herein. In some embodiments, memory 530 may include at least one of the various types of memory described herein. In some embodiments, memory 530 may store instructions (e.g., computer code, software, and/or firmware. In some embodiments, the processors 525 may perform at least one of the various operations described herein responsive to the processors 525 executing the instructions stored in memory 530. The memory 530 is shown to include a data receiver 531, an interface generator 532, a selection engine 533, and a data transmitter 534, each of which may be stored in memory as instructions, computer code, executable code, and/or software that cause, when executed by the processors, the processors 525 to perform at least one of the various operations described herein.

The computing devices 510 may refer to and/or include at least one of a mobile device, a smartphone, a tablet, a smart watch, a computer, a laptop, a desktop computer, and/or a device that may facilitate receiving and/or transmitting of information. In some embodiments, the computing device 510 may include at least one of the various devices described herein. For example, the computing devices 510 may include the client devices 448. In some embodiments, the computing devices 510 may perform operations similar to at least one of the devices described herein. For example, the computing devices 510 may perform operations similar to that of the system manager 202.

In some embodiments, the computing device 510 may include at least one processing circuit 540 and at least one interface 560. The processing circuit 540 may include at least one processor 545 and at least one memory 550. The processing circuit 540 and/or components thereof (e.g., the processors 545 and/or the memory 550) may include at least one of the various circuits, hardware, and/or circuitry described herein. The memory 550 may include and/or store at least one application 555. The application 555 may refer to and/or include at least one of a mobile application, a web portal, one or more libraries, one or more Application Programming Interfaces (APIs), and/or other applications. In some embodiments, the application 555 may include instructions and/or computer code that, when executed by the processors 545, cause the processors 545 to perform at least one of the various operations and/or functions described herein. In some embodiments, the interface 560 may refer to and/or at least one of the various communication devices, communication techniques, and/or communication protocols described herein.

The gateway 515 may refer to and/or include at least one of switches, routers, network devices, hubs, bridges, and/or other possible devices that may connect one or more devices to one another. For example, the gateway 515 may connect, over a network, a first device with a second device. In some embodiments, the gateway 515 may include at least one of the various components and/or devices described herein. For example, the gateway 515 may include system bus 254. In some embodiments, the gateway 515 may receive, from a first device, a first signal and the gateway 515 may transmit the first signal to a second device.

In some embodiments, the building 10 may include equipment 565 and/or pieces of equipment 565. In some embodiments, the equipment 565 may include at least one of the various pieces of equipment and/or equipment systems described herein. For example, the equipment 565 may include AHU 106. In some embodiments, the equipment 565 may be controllable by a controller. For example, the equipment 565 may be controllable by the BAS controller 402.

In some embodiments, one or more operations that have been described as being performed by a first system, a first device, and/or a first component may also be performed by a second system, a second device, and/or a second component. For example, operations that have been described as being performed by the cloud system 505 may also be performed by the computing device 510.

In some embodiments, the data receiver 531 may receive operational data. For example, the data receiver 531 may receive operational data via the gateway 515. As another example, the data receiver 531 may receive operational data forwarded by the interface 535 and from the gateway 515. In some embodiments, the gateway 515 may be in communication with a plurality of pieces of building equipment. For example, the gateway 515 may communicate with the equipment 565 via one or more controllers and/or edge devices coupled with the equipment 565. As another example, the gateway 515 may be directly coupled (wireless and wired connection) with the equipment 565 such that the gateway 515 receive operational data from the equipment 565.

In some embodiments, the data receiver 531 may receive operational data that pertains to the equipment 565. For example, the data receiver 531 may receive timeseries data, sensor measurement data, equipment runtime information, and/or fault information. As another example, the data receiver 531 may receive data strings that represent and/or indicate information associated with operation of the equipment 565.

In some embodiments, the interface generator 532 may generate an interface. For example, the interface generator 532 may generate a user interface for display by a display device (e.g., computer, monitor, tablet, screen, etc.). As another example, the interface generator 532 may provide the processors 525 with instructions to update the interface 560. In some embodiments, the gateway 515 may forward and/or otherwise transmit one or more signals to the computing device 510 to update the interface 560.

In some embodiments, the interface generator 532 may generate a Graphical User Interface (GUI). For example, the GUI may include a graphical representation of at least a portion of the operational data received by data receiver 531. In another example, the GUI may include a plurality of selectable elements. The selectable elements may be associated with at least one of the respective portions of the operational data or respective pieces of building equipment of the plurality of pieces of building equipment.

In some embodiments, the selection engine 533 may receive a selection. For example, the selection engine 533 may receive the selection forwarded by the interface 535 and from the gateway 515. In another example, the selection engine 533 may receive the selection from the GUI generated by the interface generator 532. In some embodiments, the selection may be a selection of a first selectable element of a plurality of selectable elements generated by interface generator 532. In some embodiments, the selectable elements may include icons, images, buttons, or tabs on the interface 535. For example, an interaction with an icon on the interface 535 may cause the gateway 515 to send one or more signals to transmit the selection to the selection engine 533.

In some embodiments, the selection engine 533 may receive a selection that pertains to a piece of building equipment. For example, the plurality of selectable elements displayed on the interface 535 may be associated with at least one of the respective portions of the operational data or respective pieces of building equipment from a plurality of pieces of building equipment. The selection received by the selection engine 533 may pertain to a first piece of building equipment that has experienced an equipment fault. For example, the user interface may include alerts and/or flags correspond to equipment with detected equipment faults. To continue this example, the selection engine 533 may receive a selection of a corresponds piece of equipment associated with the detected equipment faults.

In some embodiments, the data transmitter 534 may transmit data. For example, the data transmitter 534 may transmit data via the gateway 515. In some embodiments, the gateway 515 may be in communication with a plurality of pieces of building equipment. For example, the gateway 515 may communicate with the equipment 565 via one or more controllers and/or edge devices coupled with the equipment 565. As another example, the gateway 515 may be directly coupled (wireless and wired connection) with the equipment such that the gateway 515 may transmit data to the equipment 565.

In some embodiments, the data transmitter 534 may transmit one or more control signals that pertains to an equipment fault. For example, the data transmitter 534 may transmit the control signals to the equipment 565. In this example, an HVAC controller may receive a control signal from the data transmitter 534 to adjust the setpoint. The data transmitted by the data transmitter 534 may be related to the selection received by the selection engine 533. For example, the equipment 565 that receives the control signal may be the equipment associated with the selection received by the selection engine 533.

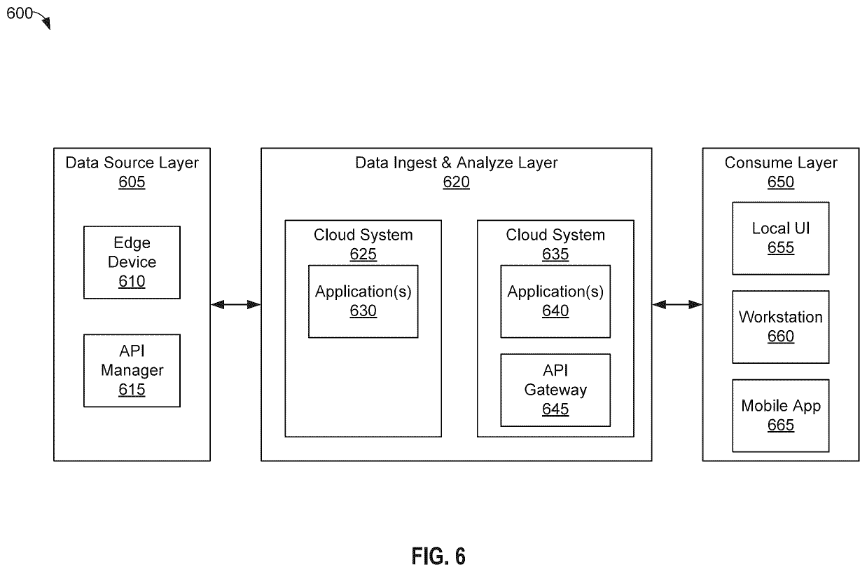

FIG. 6 is a flow diagram illustrating communication between one or more components of a system architecture 600, according to some embodiments. In some embodiments, the system architecture 600 may refer to and/or be implemented as the system 500. For example, one or more components of the system 500 may communicate using the system architecture 600. In some embodiments, the system architecture 600 may include at least one system, device, and/or component of the system 500. For example, the system architecture 600 may include the cloud system 505. In some embodiments, at least one system, device, and/or component of the system 500 may perform operations similar to that of the system architecture 600 and/or a component thereof. In some embodiments, systems, devices, and/or components of the system architecture 600 may be added, removed, integrated, combined, separated, rearranged, relocated, and/or replaced. For example, the system architecture 600 may be illustrated as including a first component and a second component and the system architecture 600 may be modified to have the second component removed from the system architecture 600.

In some embodiments, the system architecture 600 may include one or more applications and/or entities. For example, the system architecture 600 may include at least one of request application (e.g., an application that is requesting information) and at least one response application (e.g., an application that provides responses to the request application. In some embodiments, the system architecture 600 may include at least one consume layer 650, at least one data ingest and analyze layer 620, and at least one data source layer 605. In some embodiments, the one or more applications of the system architecture 600 may include at least one of the various systems, devices, and/or components described herein. For example, the data ingest and analyze layer 620 may include and/or be implemented as the cloud system 505.

As shown in FIG. 6, the data source layer 605 is shown to include at least one gateway (shown as edge device 610) and at least one Application Programming Interface (API) manager 615. In some embodiments, the gateway may refer to and/or include the gateway 515. In some embodiments, the edge device 610 and the API manager 615 may be integrated into a single device. For example, a first device may include the edge device 610 and the API manager 615. The edge device 610 and the API manager 615 may be communicably coupled with one another. For example, the edge device 610 and the API manager 615 may transmit signals between one another. The edge device 610 may be in communication with at least one of the various controllers described herein. For example, the edge device 610 may in communication with the BAS controller 402. In some embodiments, the edge device 610 may serve as and/or provide an Internet of Things (IoT) integration. For example, the edge device 610 may communicate with a mobile device and the mobile device, via the edge device 610, may be able to communicate with a controller.

In some embodiments, the data source layer 605 may be in communication with at least one of the data ingest and analyze layer 620 and/or the consume layer 650. For example, the API manager 615 may communicate, via an API gateway 645, with a cloud system 635. As another example, the edge device 610 may communicate with a desktop computer that shares a common network with the edge device 610 (e.g., the network 446). In some embodiments, the desktop computer (shown as local UI 655 in FIG. 6) may be a localized and/or admin computing device. For example, the desktop computer may be a device that is utilized by an admin of the building 10.

In some embodiments, the data ingest and analyze layer 620 may include the cloud system 635 and the cloud system 625. In some embodiments, the cloud system 635 and the cloud system 625 may be combined into a single device and/or component. In some embodiments, systems, devices, and/or components of at least one of the cloud system 635 and/or the cloud system 625 may be separated. As shown in FIG. 6, the cloud system 625 is in communication with the edge device 610 and the cloud system 635. In some embodiments, the cloud system 625 may receive, from the edge device 610, event information (e.g., building operational data, timeseries data, control logic information, controller runtime information, etc.). In some embodiments, the cloud system 625 may receive at least one of the various types of information described herein. In some embodiments, the cloud system 625 and/or a component thereof may process the information received from the edge device 610. For example, the cloud system 625 may receive timeseries data and the cloud system 625 may examine (e.g., process) the information to identify equipment faults. As another example, the edge device 610 may process the information by forwarding the information to a subsequent component. In some embodiments, the cloud system 625 may process the information by identifying pieces of building equipment. For example, the cloud system 625 may identify, via the information, the equipment 565. As another example, the cloud system 625 may determine that a first portion of the information pertains to a first piece of equipment 565 and that a second portion of the information pertains to a second piece of equipment 565.

In some embodiments, the cloud system 625 may provide the information to the cloud system 635. For example, the cloud system 625 may receive information from the edge device 610, the cloud system 625 may process the information, and the cloud system 625 may then provide the information to the cloud system 635. In some embodiments, the cloud system 635 may separate, segment, parse, and/or otherwise organize the information provided by the cloud system 625. For example, the cloud system 635 may receive a first piece of information that pertains to a new piece of equipment and the cloud system 635 may add the new piece of equipment to an asset graph. As another example, the cloud system 635 may receive telemetry information and the cloud system 635 may add the telemetry information to a telemetry database.

In some embodiments, the cloud system 635 may communicate with one or more remote devices. For example, the cloud system 635 may communicate with a device that is located outside of a localized network of the building 10. In some embodiments, the cloud system 635 may communicate with the computing devices 510.

In some embodiments, the cloud system 635 may indirectly communicably couple the edge device 610 with the computing devices 510. For example, the cloud system 635 may be in communication with both the edge device 610 and the computing devices 510. To continue this example, the cloud system 635 may receive a first message from the computing devices 510 and the cloud system 635 may provide the first message to the edge device 610. As shown in FIG. 6, API gateway 645 is shown to communicably couple edge device 610 with workstation 660 and mobile app 665.

In some embodiments, the workstation 660 may refer to and/or include a computing device that is accessing a web portal and/or that is utilizing an application. For example, the workstation 660 may include a desktop computer that is accessing a webpage. In some embodiments, the mobile app 665 may refer to and/or include a computing device that includes and/or has stored a mobile application. For example, the mobile app 665 may include the computing device 510.

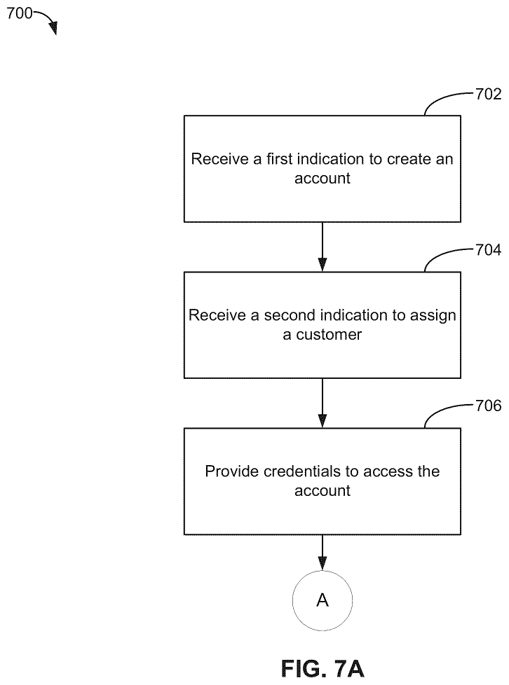

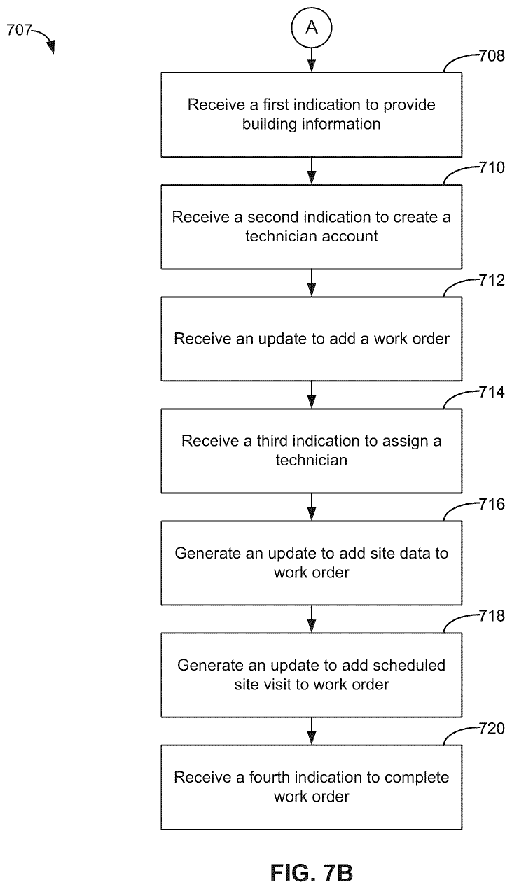

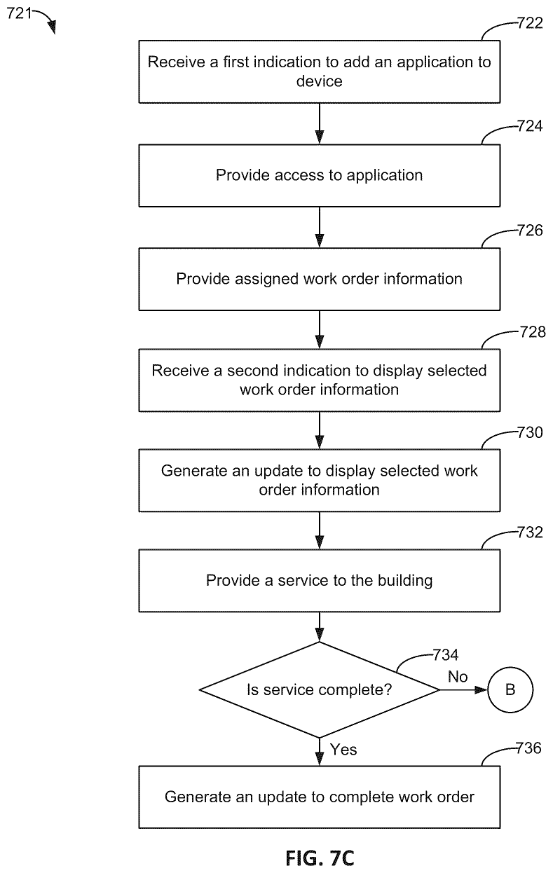

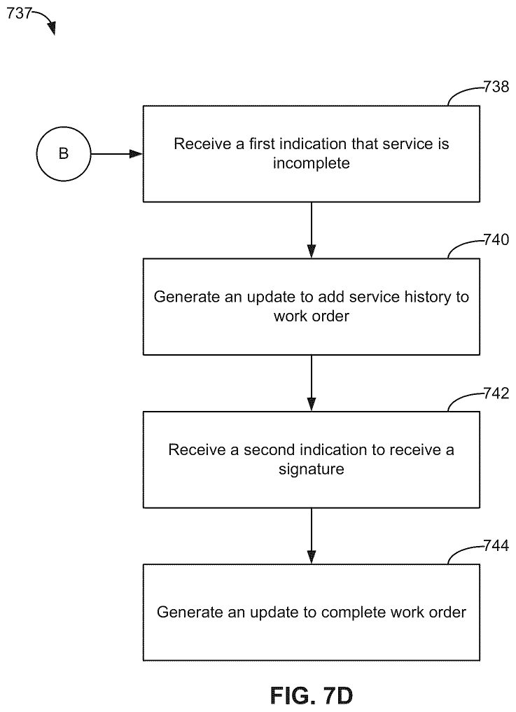

FIG. 7A is a flow diagram of a process 700 for providing remote integration of devices into a BAS, according to some embodiments. In some embodiments, at least one step and/or element of the process 700 may be performed by at least one system, device, and/or component of the system 500. For example, the cloud system 505 may perform at least one step of the process 700. In some embodiments, at least one step and/or element of the process 700 may be performed by at least one system, device, and/or component of the system architecture 600. In some embodiments, the computing device 510 described in FIG. 7A is associated with a customer user.

It should be understood that at least one of the various computing systems and/or computing devices described herein may perform at least one step and/or element of the process 700. For example, the gateway 515 may perform at least one of the steps of the process 700. It should also be understood that the memory 530 may receive instructions to cause the processors 525 to execute one or more steps of the process 700 described herein.

At step 702, an indication to create an account may be received. For example, the cloud system 505 may receive a first indication from the computing device 510. The cloud system 505 may receive the first indication responsive to an interaction with the interface 560. For example, an operator of the computing device 510 may select a given icon of the interface 560 to cause transmission of the indication to the cloud system 505, via the gateway 515. In some embodiments, the cloud system 505 may access the memory 530 to receive instructions to create the account.

At step 704, an indication to assign a customer may be received. For example, the cloud system 505 may receive a second indication that identifies a customer, client, or entity to assign to the account created in step 702. The cloud system 505 may receive the second indication responsive to an interaction with the interface 560. In some embodiments, the cloud system 505 may access the memory 530 to receive instructions to create the account. For example, the account may assign a building to the account, and the building may be assigned to the identified customer, client, or entity.

At step 706, credentials to the account may be provided. For example, the cloud system 505 may transmit, via the gateway 515, one or more signals to provide the computing device 510 with credentials to access the account created in step 702. As another example, the cloud system 505 may cause the computing device 510 to display one or more input components on the interface 560 to receive credentials provided by an operator of the computing device 510. In some embodiments, the credentials may specify and/or establish permissions for the account. For example, the credentials may specify which buildings the computing device 510 may be able to control and/or communicate with. As another example, the credentials may establish what permissions and/or capabilities the computing device 510 may have.

FIG. 7B is a flow diagram of a process 707 for providing remote integration of devices into a BAS, according to some embodiments. In some embodiments, at least one step and/or element of the process 700 may be performed by at least one system, device, and/or component of the system 500. For example, the cloud system 505 may perform at least one step of the process 700. In some embodiments, at least one step and/or element of the process 700 may be performed by at least one system, device, and/or component of the system architecture 600. In some embodiments, the computing device 510 described in FIG. 7A is associated with a contractor user.

It should be understood that at least one of the various computing systems and/or computing devices described herein may perform at least one step and/or element of the process 707. For example, the gateway 515 may perform at least one of the steps of the process 707. It should also be understood that the memory 530 may receive instructions to cause the processors 525 to execute one or more steps of the process 707 described herein.

At step 708, an indication to provide building information may be received. For example, the cloud system 505 may receive the first indication from the computing device 510. The cloud system 505 may receive the indication responsive to an interaction with the interface 560. For example, the interface 560 may receive credentials from the operator of the computing device 510. Upon receiving the first indication, the cloud system 505 may access the memory 530 to receive instructions to provide the building information associated with the credentials. The cloud system 505 may then send one or more signals, via the gateway 515, to transmit the building information to the computing device 510. In some embodiments, the building information may include work orders that have been assigned to equipment in the building.

At step 710, an indication to create a second account may be received. For example, the cloud system 505 may receive a second indication from the computing device 510. The cloud system 505 may receive the second indication responsive to an interaction with the interface 560. For example, an operator of the computing device 510 may select a given icon of the interface 560 to cause transmission of the indication to the cloud system 505, via the gateway 515. In some embodiments, the cloud system 505 may access the memory 530 to receive instructions to create the second account. In some embodiments, credentials may be assigned to the second account. For example, the cloud system 505 may assign the second account to the credentials created in step 706. In some embodiments, the second account is assigned to a technician.

At step 712, an update to add a work order may be received. For example, the cloud system 505 may transmit, via the gateway 515, one or more signals to provide the computing device 510 with a work order. The cloud system 505 may transmit the signals to the computing device 510 in response to an interaction on the interface 560. For example, the interface 560 may display, via the workstation 660, information pertaining to the building. The interface 560 may also display one or more icons that each correspond to a piece of equipment in the building. In response to a selection of the icons, the cloud system 505 may access the memory 530 to receive instructions to create the work order. For example, the work order may pertain to an equipment fault.

At step 714, an indication to assign a technician may be received. For example, the cloud system 505 may receive a third indication that identifies a technician to assign to the work order created in step 712. The cloud system 505 may receive the indication in response to an interaction on the interface 560. For example, the interface 560 may display one or more input components to receive technician information provided by the operator of the computing device 510. In some embodiments, the technician information may include a name or a credential relating to the technician. The cloud system may access the memory 530 to receive instructions to update the work order to assign the technician. In some embodiments, the work order may be transmitted to the technician account. For example, the cloud system 505 may transmit the work order to the technician account created in step 710.

At step 716, an update to add site data to the work order may be generated. For example, the cloud system 505 may cause the computing device to display one or more input components on the interface 560 to receive site data provided by the operator of the computing device 510. In some embodiments, the site data may include alarm codes, fault codes, troubleshooting guides, and/or service history. The site data received by the interface 560 may then be transmitted, via the gateway 515, to the cloud system 505. The cloud system 505 may then access the memory 530 to receive instructions to add the site data to the work order.

At step 718, an update to add a scheduled site visit to the work order may be generated. For example, the cloud system 505 may cause the computing device to display one or more input components on the interface 560 to receive site visit data provided by the operator of the computing device 510. In some embodiments, site visit data may include a date and/or time for the technician user to visit the building or a date and/or time for the technician user to review fault information that may have been provided by the cloud system 625, the edge device 610, etc. The site visit data may then be transmitted, via the gateway 515, to the cloud system 505. The cloud system 505 may then access the memory 530 to receive instructions to add the site visit data to the work order.

At step 720, an indication to complete the work order may be received. For example, the cloud system 505 may receive a fourth indication that identifies a customer signature, from the computing device 510. The cloud system 505 may receive the fourth indication in response to an interaction from the interface 560. For example, the interface 560 may include one or more selectable icons that allow the computing device 510 to receive a customer signature. The customer signature may be received as confirmation that the work order is complete. The customer signature data may then be transmitted, via the gateway 515, to the cloud system 505. The cloud system 505 may then access the memory 530 to receive instructions to complete the work order.

FIG. 7C is a flow diagram of a process 721 for providing remote integration of devices into a BAS, according to some embodiments. In some embodiments, at least one step and/or element of the process 700 may be performed by at least one system, device, and/or component of the system 500. For example, the cloud system 505 may perform at least one step of the process 700. In some embodiments, at least one step and/or element of the process 700 may be performed by at least one system, device, and/or component of the system architecture 600. In some embodiments, the computing device 510 described in FIG. 7C is associated with a technician user. For example, the computing device 510 associated with the technician user may communicate with the cloud system 505 to allow remote operation of the application.

It should be understood that at least one of the various computing systems and/or computing devices described herein may perform at least one step and/or element of the process 721. For example, the gateway 515 may perform at least one of the steps of the process 721. It should also be understood that the memory 530 may receive instructions to cause the processors 525 to execute one or more steps of the process 721 described herein.

In step 722, an indication to add an application to a device may be received. For example, the cloud system 505 may receive a first indication from the computing device 510. The indication may be sent to the cloud system 505 as a result of an interaction on the interface 560. For example, one or more icons may be selected on the interface 560 in order to transmit the first indication to the cloud system 505. In response to receiving the first indication, the cloud system 505 may access the memory 530 to retrieve instructions to install the application. Upon executing the instructions, the cloud system 505 may send one or more signals, via the gateway 515, to transmit the application to the computing device 510.

In step 724, access to the application may be provided. For example, the cloud system 505 may cause the computing device 510 to display one or more input components on the interface 560 to receive credentials provided by an operator of the computing device 510. In some embodiments, the credentials may be the credentials received in step 710. Upon receiving the credentials, the cloud system 505 may access the memory 530 to receive instructions to provide access to the account associated with the credentials to the computing device 510. The cloud system 505 may then send one or more signals, via the gateway 515, to provide the computing device 510 with the account. The application may then be accessed on the computing device 510 using the account.

In step 726, assigned work order information is provided. For example, the cloud system 505 may transmit, via the gateway 515, one or more signals to provide the computing device 510 with work order information. In some embodiments, the cloud system 505 uses the credentials to provide the assigned work order information to the computing device 510. In some embodiments, the interface 560 is updated to display the work order information assigned to the account. For example, the computing device 510 may provide and/or display a user interface including a graphical representation of one or more work orders.

In step 728, an indication to display selected work order information is received. For example, the cloud system 505 may receive a second indication to display information related to a selected work order, from the computing device 510. The second indication may be sent to the cloud system 505 as a result of an interaction on the interface 560. For example, a signal may be transmitted to the cloud system 505 as a result of an icon on the interface 560 being selected. The icon may correspond to a piece of work order information displayed in step 728.

In step 730, an update to display selected work order information is generated. For example, the cloud system 505 may access memory 530 to receive instructions to transmit the selected work order information to the computing device 510. In some embodiments, the interface 560 will be updated with the identified work information. For example, the cloud system 505 may send one or more signals, via the gateway 515, to transmit the work order information to the computing device 510. The computing device 510 may then update interface 560 to display the identified work information. In some embodiments, the interface 560 may include selectable elements (e.g., icons, buttons, toggles, etc.). For example, the selectable elements may be used to display information pertaining to given work orders.

In step 732, a service to the building may be provided. For example, the cloud system 505 may access the memory 530 to receive instructions to service the building. For example, the instructions may cause the processor 525 to produce a signal to transmit to the building. In some embodiments, the interface 560 may display one or more icons that, when selected, cause the cloud system 505 to transmit the signal to the building. The cloud system 505 may then transmit the signal, via the gateway 515, to the building. For example, the cloud system 505 may provide a signal to the edge device 610 which may cause the edge device 610 to restart.

In step 734, service status is provided. For example, the cloud system 505 may transmit, via the gateway 515, one or more signals to display the status of the work order on the computing device 510. In some embodiments, the cloud system 505 may access the memory 530 to receive instructions to communicate with the building. The processor 525 may then execute the instructions. For example, the instructions may cause the processor 525 to produce a signal to transmit to the building. In some embodiments, the cloud system 505 may receive information from the building equipment indicating the status of the service. The building equipment may send one or more signals to the cloud system 505 to receive operational data pertaining to the building equipment after the service is performed. The operational data may then provide an indication of the service status. For example, the cloud system 505 may receive an indication that the service is complete. In this instance, the process 721 proceeds to step 736. In another example, the cloud system 505 may receive an indication that the service has not been completed. In this instance, the process 721 proceeds to process 737. In response to the information received from the building, the cloud system 505 sends one or more signals, via the gateway 515, to transmit the service status to the computing device 510.

In step 736, an update to complete the work order may be generated. For example, the cloud system 505 may cause the computing device to display one or more input components on the interface 560 to receive service history information provided by the operator of the computing device 510. In some embodiments, the service history information may indicate and/or identify a piece of equipment that was replaced or a cause for a given equipment fault. The service history information may then be transmitted, via the gateway 515, to the cloud system 505. In some embodiments, the cloud system 505 may access the memory 530 to receive instructions to update the work order with the service history information. In some embodiments, the instructions may cause the work order to be marked as completed.

FIG. 7D is a flow diagram of process 737 for providing remote integration of devices into a BAS, according to some embodiments. In some embodiments, at least one step and/or element of the process 700 may be performed by at least one system, device, and/or component of the system 500. For example, the cloud system 505 may perform at least one step of the process 700. In some embodiments, at least one step and/or element of the process 700 may be performed by at least one system, device, and/or component of the system architecture 600. In some embodiments, the computing device 510 described in FIG. 7D is associated with a technician user. For example, the computing device 510 associated with the technician user may communicate with the cloud system 505 to allow onsite operation of the application.

It should be understood that at least one of the various computing systems and/or computing devices described herein may perform at least one step and/or element of the process 737. For example, the gateway 515 may perform at least one of the steps of the process 737. It should also be understood that the memory 530 may cause the processors 525 to execute one or more steps of the process 737 described herein.

In step 738, an indication that service is incomplete may be received. For example, upon completion of step 734, the cloud system 505 may receive a first indication that the service is incomplete. In some embodiments, the cloud system 505 may access the memory 530 to receive instructions. For example, the instructions may cause the cloud system 505 to update the information received in step 728. In some embodiments, the cloud system 505 may send one or more signals, via the gateway 515, to transmit the updated information to the computing device 510. In some embodiments, the interface 560 may be updated to display the updated information. For example, the interface 560 may display that the work order/ticket has not been completed. In some embodiments, the interface 560 may indicate to the operator that the building 10 must be visited to service equipment 565.

In step 740, an update to add service history to the work order may be generated. For example, the cloud system 505 may cause the computing device to display one or more input components on the interface 560 to receive service history information provided by the operator of the computing device 510. The service history information may indicate that the service was addressed. In some embodiments, the service history information may indicate and/or identify a piece of equipment that was replaced or a cause for a given equipment fault. The service history information may then be transmitted, via the gateway 515, to the cloud system 505. In some embodiments, the cloud system 505 may access the memory 530 to receive instructions to update the work order with the service history information. The instructions may then be executed by the processor 525.

In step 742, an indication to receive a signature may be received. For example, the cloud system 505 may receive a second indication to receive a signature upon completion of a service. The cloud system 505 may receive the second interaction in response to an interaction on the interface 560. For example, the interface 560 may allow the operator of the computing device 510 to provide a customer signature upon completion of a service. The cloud system 505 may then access the memory 530 to receive instructions to update the information with the signature.

In step 744, an update to complete the work order may be generated. For example, the cloud system 505 may cause the computing device 510 to display an icon on the interface 560, wherein selection of the icon indicates that the work order is completed. When the icon is selected, the computing device 510 may send a signal to the cloud system 505. The cloud system 505 may then access the memory 530 to receive instructions to update the work order. For example, the work order may be updated to indicate that it has been completed.

### User Interfaces

As described herein, the various systems, devices, and/or components may generate, present, provide, and/or display information via one or more user interfaces. In some embodiments, the user interfaces may include screens, windows, pages, sites, tabs, and/or among other possible elements. The user interfaces may include Graphical User Interfaces (GUI). In some embodiments, the various user interfaces described herein may be modified, adjusted, rearranged, separated, combined, altered, and/or otherwise changed. For example, a first user interface that is shown and/or described as having a first window and a second window may be modified to have at least one of the first window and/or the second window removed. As another example, a first user interface and/or a second user interface may be combined to create a single user interface.

In some embodiments, information, features, elements, icons, buttons, and/or other possible portions that are shown and/or described with respect to a first user interface may also be included in one or more second user interfaces. For example, a control button that is shown to be included in a first user interface may also be included in a second user interface. In some embodiments, the one or more user interfaces described herein may be provided as one more screens, pages, and/or windows. In some embodiments, the one or more user interfaces described herein may be presented and/or displaying as a single user interface and information pertaining to the user interfaces may accessed by scrolling and/or navigating the single user interface.

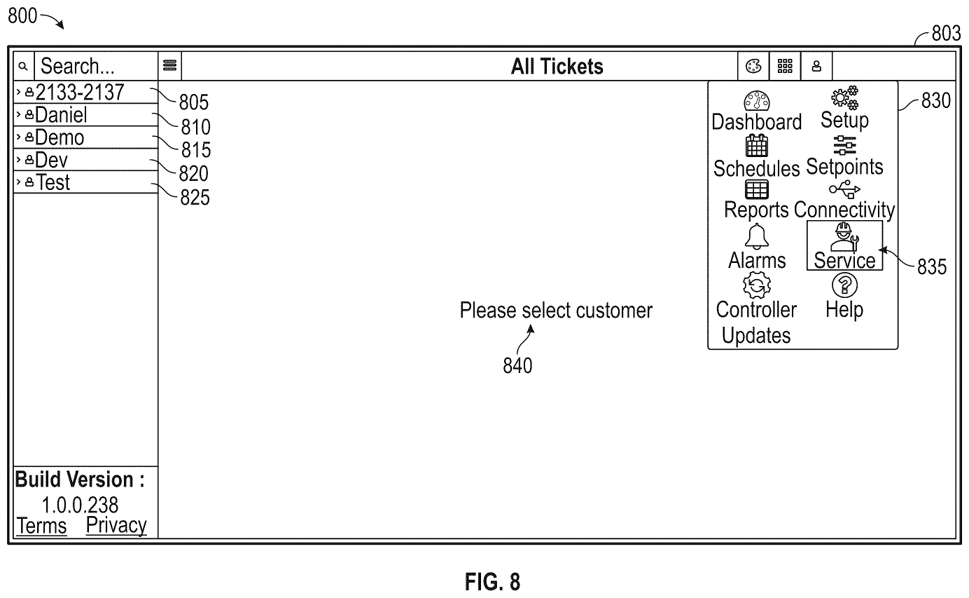

FIG. 8 depicts a user interface 800, according to some embodiments. In some embodiments, the user interface 800 may be generated, presented, provided, and/or otherwise displayed by at least one of the systems, devices, and/or components described herein. For example, the computing device 510 may display the user interface 800. The user interface 800 may include at least one ticket window 803. For example, the user interface 800 may include a portion and/or area 840 for a user to view one or more tickets. In some embodiments, the user interface 800 may include one or more elements or input components. For example, elements 805, 810, 815, 820, and 825 are shown to correspond with various tickets. In some embodiments, the contractor admin may select one or more elements (e.g., selected elements 830) to create and/or generate one or more tickets. For example, the contractor admin may select a service icon 835 to create a ticket.

In some embodiments, a service ticket and/or ticket may include one or more components. For example, the service ticket may include information pertaining to a customer and/or a site. In some embodiments, a service ticket may include components pertaining to at least one of customer details, site details, technical details, a schedule visit, notify customer, customer signature, alarms, notes, and/or priority.

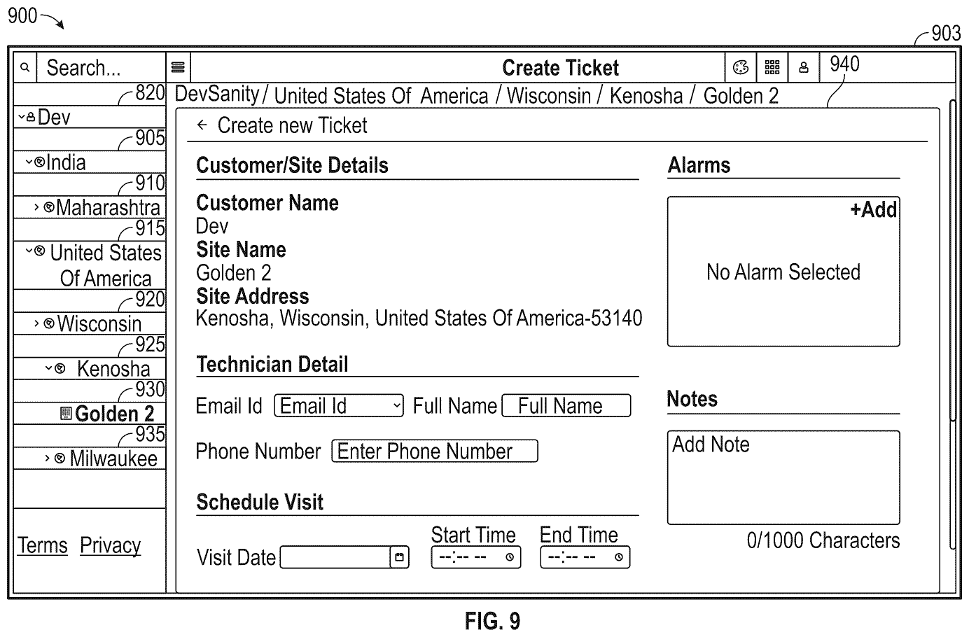

FIG. 9 depicts a user interface 900, according to some embodiments. In some embodiments, the user interface 900 is generated as a result of a selection of an icon on the user interface 800. For example, the user interface 900 is generated as a result of a technician selecting element 825 of the user interface 800. In some embodiments, the user interface 900 may include at least one create ticket window 903. For example, the user interface 900 may include a portion and/or an area 940 to enter information pertaining to a ticket. In some embodiments, the user interface 900 may include one or more selectable elements or input components to organize the tickets. For example, elements 905, 910, 915, 920, 925, 930, and 935 are shown to correspond to various ticket categories, such as a site name or site address associated with a ticket. In some embodiments, the user interface 900 may include at least one of the ticket components described herein.

In some embodiments, the contractor admin creating a ticket may cause a notification (e.g., an email, a text, a prompt, a banner, etc.) to be provided to a mobile device of the technician. In some embodiments, the technician may be able to access and/or interface with the building 10 responsive to the contractor admin provided access to the building 10. For example, the technician may be able to interface with the building responsive to completion of at least one step of the process 700.

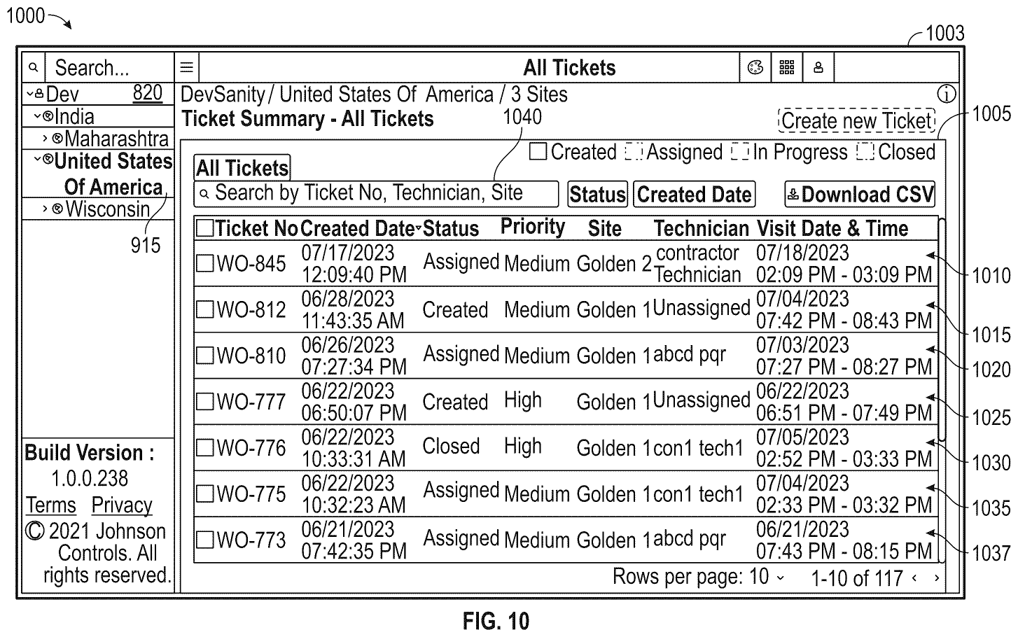

FIG. 10 depicts a user interface 1000, according to some embodiments. In some embodiments, the user interface 1000 is generated as a result of a selection of an icon on the user interface 900. For example, the user interface 1000 is generated as a result of a technician selecting element 915 of the user interface 900. In some embodiments, the user interface 1000 may include a ticket summary window 1003. For example, tickets that have been generated, by the contractor admin, and/or provided to the technician may be included in the user interface 1000. In some embodiments, the user interface 1000 may include one or more selectable elements or input components to display the tickets. For example, elements 820 and 915 are shown to correspond to various ticket categories, such as customer and location assigned to the ticket. In some embodiments, the user interface 1000 may refer to and/or include a default view 1005. In some embodiments, the ticket summary may include one or more segments and/or portions. The segments may pertain to different categories. As shown in FIG. 10, the ticket summary includes a ticket number segment, a creation date segment, a status segment, a priority segment, a site segment, a technician segment, and a scheduled date segment. In some embodiments, the ticket summary may include any number of segments. For example, the ticket summary may include two segments. As another example, the ticket summary may include ten segments. Elements 1010, 1015, 1020, 1025, 1030, 1035, and 1037 are each shown to correspond to individual tickets with seven segments. In some embodiments, the ticket summary may include at least one segment pertaining to additional features. For example, the ticket summary may include a filter segment, a sort segment, a search segment 1040, an adjustable view segment (e.g., pagination), and/or a download segment.

In some embodiments, the technician may modify, adjust, and/or change one or more tickets. For example, the technician may change a schedule visit time to service a piece of equipment. In some embodiments, the contractor admin may track progress of the tickets. For example, the contractor admin may track one or more diagnostic steps that have been performed by the technician. In some embodiments, the contractor admin may access details pertaining to ongoing, pending, and/or processed tickets. In some embodiments, the contractor admin may update the ticket, view the service history. For example, the contractor admin may add notes to a ticket. In some embodiments, the technician may receive a notification response to updates to the tickets.

In some embodiments, the contractor admin may be able to delete, close, complete, and/or finalize one or more tickets. For example, the contractor admin may delete a previously generated ticket responsive to a determination that a requested service is no longer being requested. In some embodiments, the contractor admin may download a copy of the one or more tickets. For example, the contractor admin may download the tickets as a Portable Document Format (PDF).

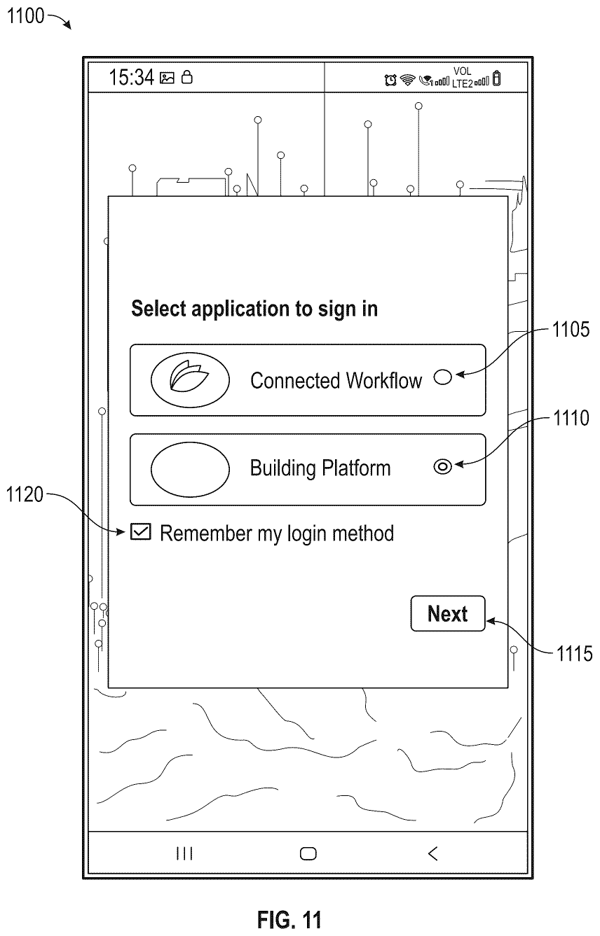

FIG. 11 depicts a user interface 1100, according to some embodiments. The user interface 1100 may include a launch screen and/or a landing pad. For example, the technician may select and/or open the application 555. To continue this example, the user interface 1100 may be presented and/or display on a mobile device of the technician. In some embodiments, the user interface 1100 may be presented responsive to completion of a technician onboarding. For example, the user interface 1100 may be generated responsive to the technician having downloaded the application 555 and responsive to the contractor admin having added the technician.

In some embodiments, the user interface 1100 may include one or more options. For example, as shown in FIG. 11, the user interface 1100 includes a connected workflow option and a Verasys option. The technician may select, via a button, at least one of the options. For example, the user interface 1100 includes a button 1105 corresponding to the connected workflow option and a button 1110 corresponding to the Verasys option. In some embodiments, the technician may be prompted to provide login information (e.g., a username and/or password) responsive to selecting at least one of the options. In some embodiments, the user interface 1100 may provide a selectable element 1120 that, when selected, saves the login information of the technician. In some embodiments, a user (e.g., the technician) may be prompted to agree to terms and/or conditions. For example, the technician may be prompted to acknowledge a privacy notice. In some embodiments, the technician may be prompted to complete the login. For example, element 1115 may be selected to login to the application using the provided login information.

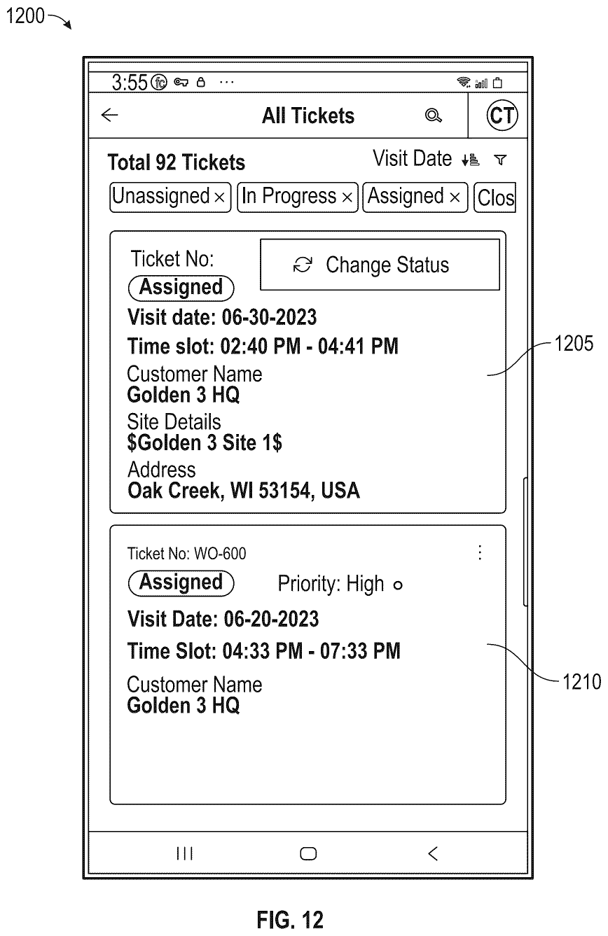

FIG. 12 depicts a user interface 1200, according to some embodiments. In some embodiments, the user interface 1200 may include a ticket screen for a mobile application. For example, the user interface 1200 may be included and/or displayed by the application 555. The user interface 1200 may include an application dashboard. For example, the user interface 1200 may include tickets. In some embodiments, the user interface 1200 may display a preview of the tickets, which may include at least one of a visit date, time slot, status, customer name, site details, and address assigned to the ticket. For example, elements 1205 and 1210 illustrate previews of assigned tickets. In some embodiments, the order and/or display of the tickets may be modified. For example, as shown in FIG. 12, the user interface 1200 includes an unassigned box, an in progress box, and an assigned box. To continue this example, selection and/or deselection of at least one of the boxes (e.g., unassigned box, progress box, and/or assigned box) may adjust and/or change the application dashboard.

In some embodiments, the application dashboard may include one or more ticket statuses. For example, the application dashboard may include an all tickets box, an assigned tickets box, an in progress box, a closed box, and/or an unassigned box.

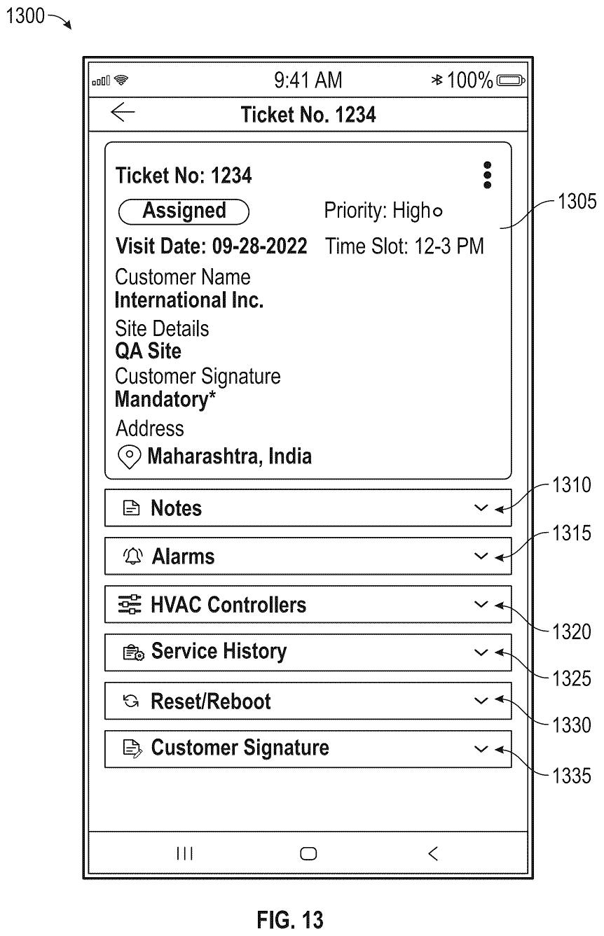

FIG. 13 depicts a user interface 1300, according to some embodiments. The user interface 1300 may include at least one ticket listing. For example, the user interface 1300 may list information pertaining to a ticket. In some embodiments, the ticket listing may include information pertaining to at least one of the tickets shown in the user interface 1200. For example, the user interface 1300 may include one or more window, such as window 1305, to present information pertaining to at least one of the tickets shown in the user interface 1200. In some embodiments, the user interface 1300 may include a ticket view screen for a mobile application. For example, the user interface 1300 may include a ticket view screen for the application 555. In some embodiments, the user interface 1300 may include one or more features. For example, the user interface 1300 may include at least one of a filter function, a sorting function, and/or a search function. In some embodiments, the filter function may filter tickets based on status. In some embodiments, the sorting function may sort tickets based on visit date and/or priority. In some embodiments, the technician may utilize the search function to search for tickets by site name and/or by ticket number. In some embodiments, the user interface 1300 may include a menu icon (shown as three dots in FIG. 13). In some embodiments, the technician may select the menu icon to change a status of at least one ticket.

In some embodiments, the user interface 1300 may include ticket details. For example, the user interface 1300 may include information that was added by the contractor admin. As another example, the ticket details may include a priority level for a given ticket. In some embodiments, the ticket details may include at least one of the various types and/or examples of ticket information and/or ticket details described herein. In some embodiments, the user interface 1300 may include one or more elements or input components. For example, elements 1310, 1315, 1320, 1325, 1330, and 1335 are shown to correspond with various pieces of information pertaining to the ticket details (e.g., notes, alarms, HVAC controllers, service history, reset/reboot, customer signature, etc.). In some embodiments, the user interface 1300 may include a selectable address pertaining to a site (e.g., a building). The technician may select and/or click the address to receive directions to the site.

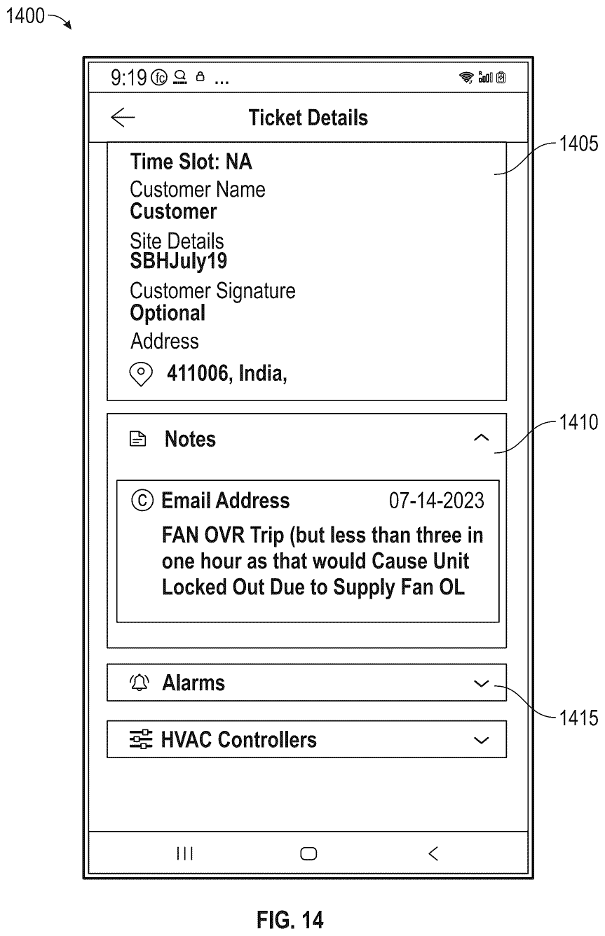

FIG. 14 depicts a user interface 1400, according to some embodiments. The user interface 1400 may include a ticket detail screen for a mobile application, according to some embodiments. For example, the user interface 1400 includes a ticket details portion 1405 which may include details pertaining to at least one of the tickets described herein. As shown in FIG. 14, the user interface 1400 includes a notes portion 1410 which includes information that was entered by the contractor admin. In some embodiments, the notes portion may include various types of information. For example, the notes portion may include contact information pertaining to the customer user. In some embodiments, the notes portion may include information that was provided and/or entered during generation of a ticket. For example, the notes portion may include information that was entered by the contractor admin as the contractor admin generated a ticket. In some embodiments, the user interface 1400 may include additional elements corresponding with various pieces of information. For example, alarms button 1415 is shown to correspond with alarm information that may relate to the ticket.

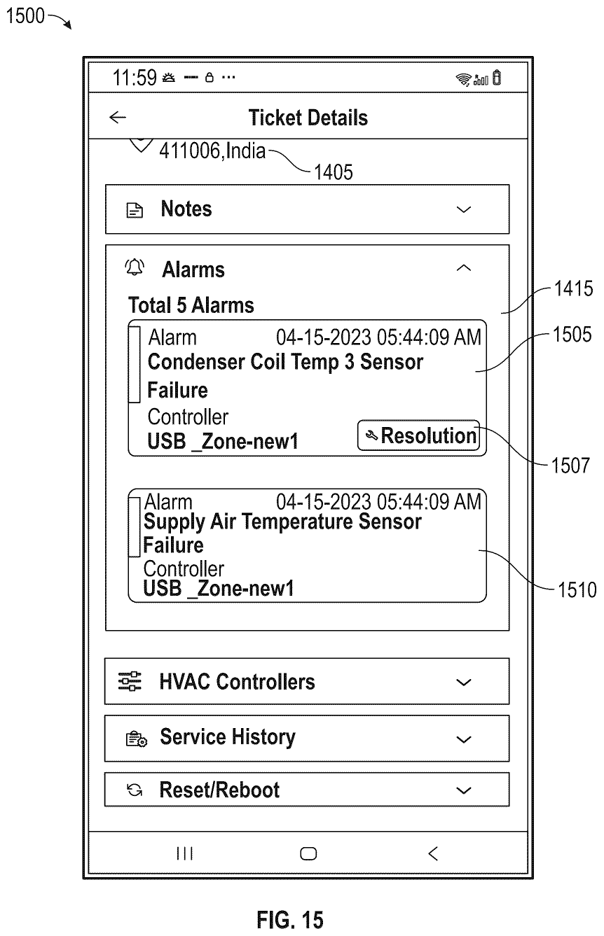

FIG. 15 depicts a user interface 1500, according to some embodiments. The user interface 1500 may include information pertaining to one or more alarms for a piece of building equipment. In some embodiments, the user interface 1500 may include information pertaining to alarms of the equipment 565. For example, elements 1505 and 1510 are shown to display information corresponding to two alarms related to the selected ticket. To continue this example, elements 1505 and 1510 may be displayed as a result of alarms button 1415 being selected by the technician. In some embodiments, the alarms may pertain to one or more tickets. In some embodiments, a ticket may be completed and/or resolved responsive to a technician addressing at least one of the alarms. For example, the user interface 1500 may provide a resolution to the alarm in response to resolution button 1507.

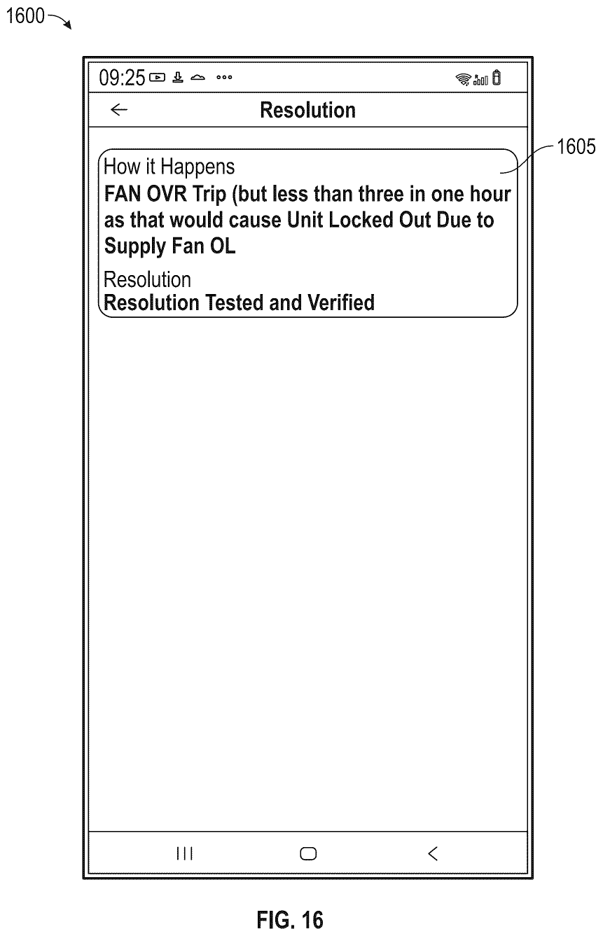

FIG. 16 depicts a user interface 1600, according to some embodiments. In some embodiments, the user interface 1600 may include a resolution screen for a mobile application. For example, the user interface 1600 may include a resolution screen for the application 555. In some embodiments, the user interface 1600 may include background information pertaining to one or more alarms. For example, the user interface 1600 may include a description of what triggered and/or caused an alarm. In some embodiments, the user interface 1600 may include confirmation that the alarm has been addressed. For example, the user interface 1600 may include one or more window, such as window 1605, to present a description indicating that the resolution was tested and verified.

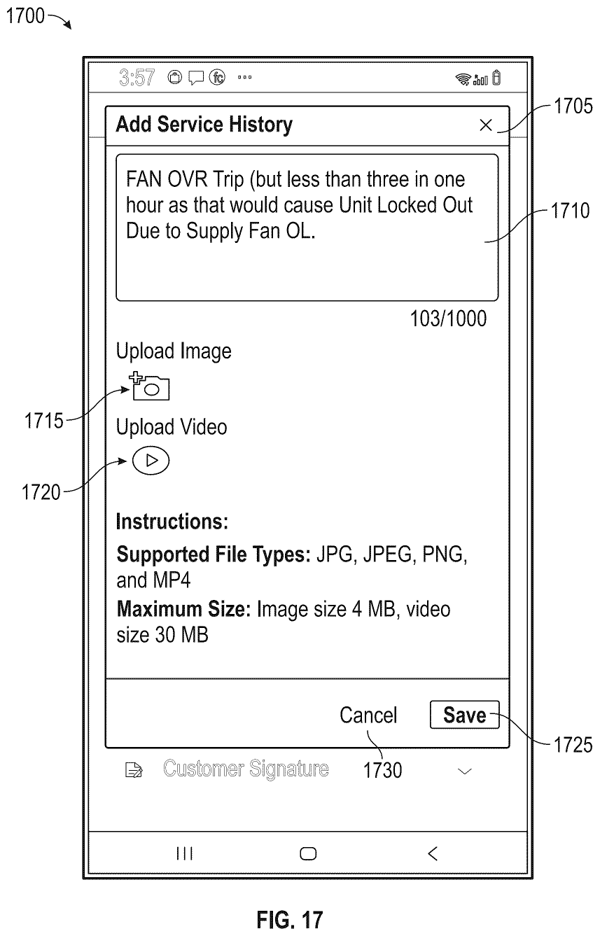

FIG. 17 depicts a user interface 1700, according to some embodiments. In some embodiments, the user interface 1700 may include a pop-up window 1705 for a mobile application. For example, the user interface 1700 may include a pop-up window 1705 over a screen of the application 555. In some embodiments, the user interface 1700 may include a text box 1710 and/or an entry field 1710. For example, the technician may enter, via the text box 1710, steps that the technician performed. As another example, the technician may enter future troubleshooting steps.

In some embodiments, the technician may enter information, via the user interface 1700 to document and/or record services that were performed by the technician. In some embodiments, the technician may upload and/or provide an image and/or a video. For example, elements 1715 and 1720 are selectable icons that allow the technician to upload the image or video. In some embodiments, the user interface 1700 may include one or more elements to cancel or save the entered information. For example, element 1725 is shown as a save button and element 1730 is shown as a cancel button. In some embodiments, the contractor admin may provide information via the user interface 1700. For example, the contractor admin may enter information on behalf of the technician.

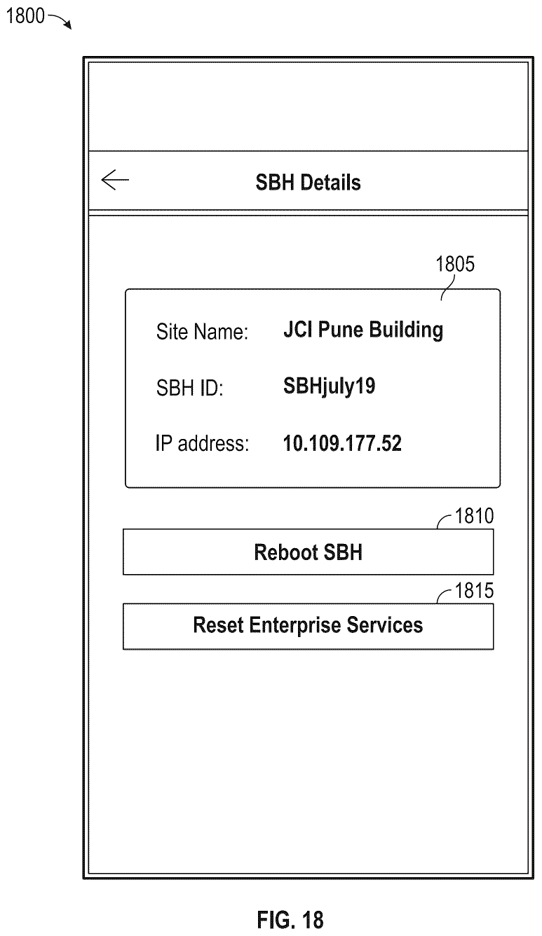

FIG. 18 depicts a user interface 1800, according to some embodiments. In some embodiments, the user interface 1800 may include a gateway screen for a mobile application. For example, the user interface 1800 may include a screen for the application 555. In some embodiments, the user interface 1800 may include one or more windows, such as window 1805, to present details relating to the gateway screen. For example, window 1805 may include information pertaining to at least one of a site name, SBH ID, or an IP address. In some embodiments, the user interface 1800 may include one or more buttons. For example, the user interface 1800 may include selected elements and/or portions. In some embodiments, a selection of at least one of the buttons may cause one or more signals to be generated and/or transmitted.

As an example, as shown in FIG. 18, the user interface 1800 include a reboot SBH button 1810. To continue this example, selection of the reboot SBH button 1810 may cause one or more signals to be transmitted to the edge device 610. In some embodiments, the one or more signals may cause the edge device 610 to reboot. As another example, the user interface 1800 may include a reset enterprise services button 1815. To continue this example, selection of the reset enterprise services button 1815 may cause one or more signals to be transmitted to the edge device 610. In some embodiments, the one or more signals may cause the edge device to reset a service. In some embodiments, the one or more buttons of the user interface 1800 may be selected to generate and/or transmit at least one of the various signals described herein.

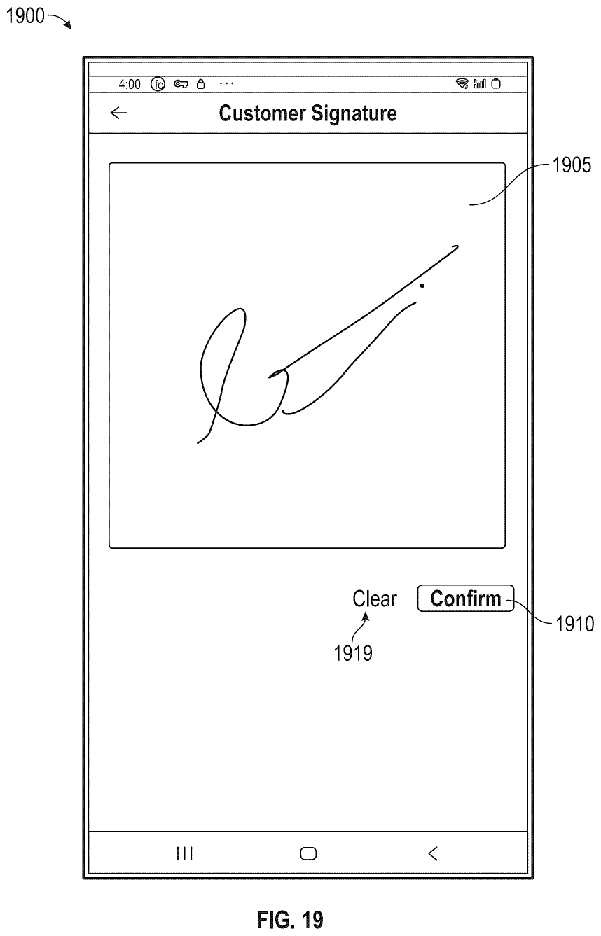

FIG. 19 depicts a user interface 1900, according to some embodiments. The user interface 1900 may include a prompt to provide a customer signature. For example, the technician may provide (e.g., select a button) an indication that a ticket has been completed. To continue this example, the user interface 1900 may be generated to prompt the technician to ask for a customer signature (e.g., a signature of the customer admin). As shown in FIG. 19, the user interface includes a window and/or a box 1905, for which the customer may provide and/or enter their signature. In some embodiments, the customer admin may establish and/or define given tickets and/or given alarms for which customer signatures may be provided. In some embodiments, the user interface 1900 may include one or more elements to save the customer signature. For example, element 1919 is shown as a clear button and element 1910 is shown as a confirm button.

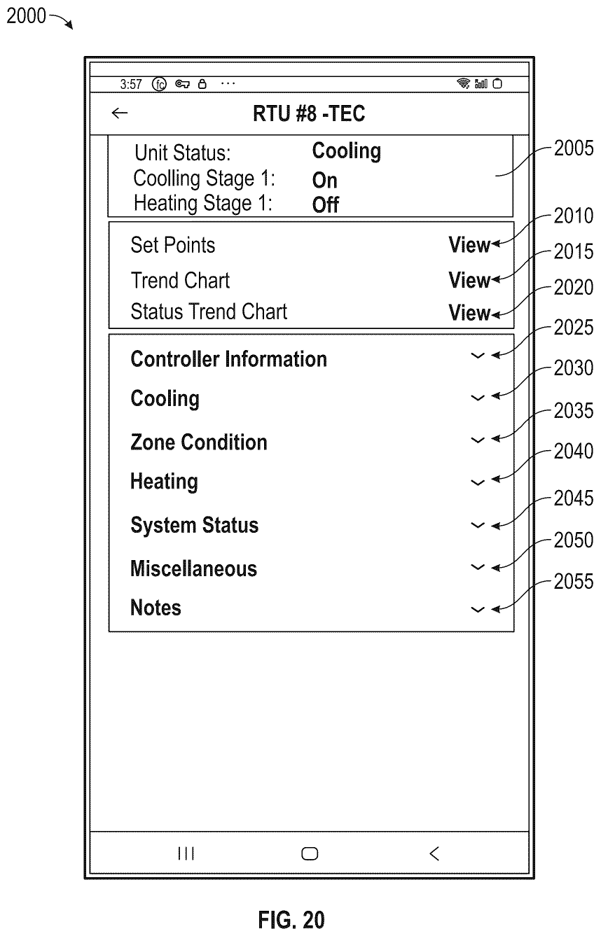

FIG. 20 depicts a user interface 2000, according to some embodiments. The user interface 2000 may include information pertaining to one or more controllers. For example, the user interface 2000 may include information pertaining to at least one of the controllers described herein. In some embodiments, the user interface 2000 may include one or more windows, such as window 2005, to present information pertaining to an individual selected controller. In some embodiments, the technician may view information relating to the controller, such as set points, trend charts, or status trend charts of the controller. For example, elements 2010, 2015, and 2020 are shown to correspond to a selection of at least one of the set point, trend chart, or status trend chart. In some embodiments, the user interface 2000 may include information pertaining to heating and cooling temperatures, zone conditions, occupancy status, and other related information. For example, elements 2025, 2030, 2035, 2040, 2045, 2050, and 255 are shown to correspond with various pieces of information. In some embodiments, the technician may access, via the user interface 2000, information pertaining to the controller to identify a potential root cause of an alarm, a fault, and/or a failure.

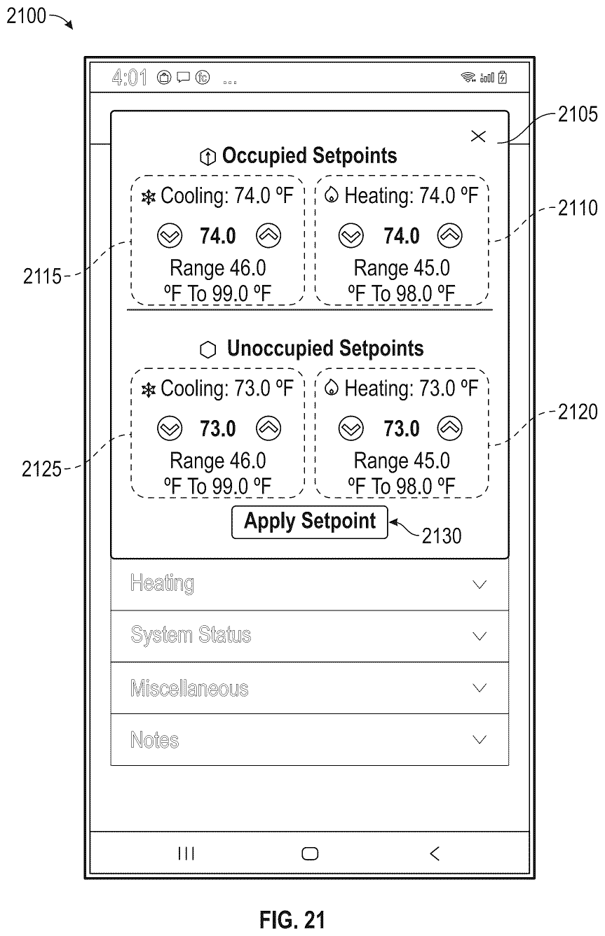

FIG. 21 depicts a user interface 2100, according to some embodiments. In some embodiments, the user interface 2100 may be a pop window 2105 that is presented and/or generated on top off and/or over the user interface 2000. In some embodiments, the user interface 2100 may be generated responsive to the technician selecting a view button that pertains to setpoints. As shown in FIG. 21, the user interface 2100 may include heating and/or cooling setpoints. For example, elements 2110, 2115, 2120, and 2125 correspond to various heating and/or cooling setpoints of a selected controller. The user interface 2100 may include arrows and/or buttons to adjust the various setpoints. In some embodiments, the technician may select apply setpoint button 2130 to cause one or more signals to transmitted to a given controller. For example, selecting the apply setpoint button 2130 may cause control signals to be transmitted to an HVAC controller.

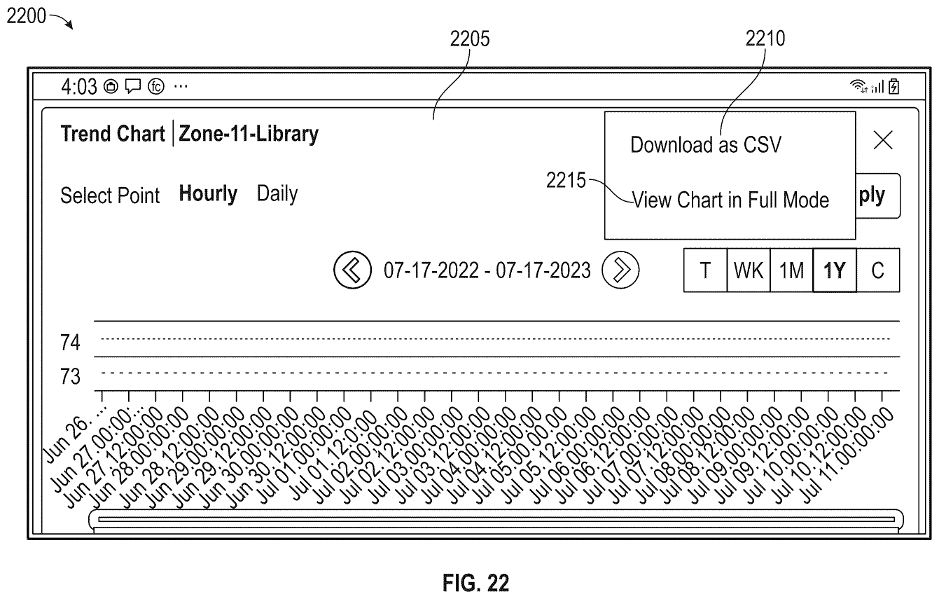

FIG. 22 depicts a user interface 2200, according to some embodiments. The user interface 2000 may include a trend chart 2205. In some embodiments, the user interface 2200 may be generated and/or presented responsive to the technician selecting a view button that pertains to the trend chart. For example, the user interface 2200 may be generated responsive to the technician selecting, via the user interface 2000, the view button that pertains to a trend chart.

In some embodiments, the trend chart, included in the user interface 2200, may be adjusted, changed, and/or modified. For example, the technician may adjust the trend chart from an hourly view to a daily view and/or vice versa. As another example, the technician may adjust a date range. In some embodiments, the trend chart may be downloaded and/or copied. For example, the technician may select download as CSV button 2210 to cause the trend chart to be downloaded. In some embodiments, the trend chart may be displayed in an alternative view. For example, the technician may select view chart in full mode button 2215 to cause the trend chart to be displayed on an updated interface.

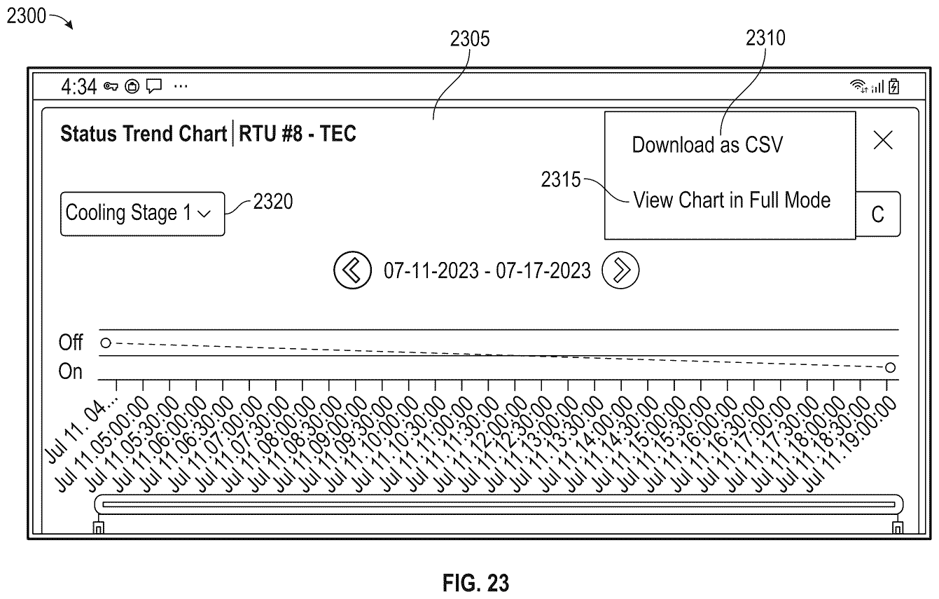

FIG. 23 depicts a user interface 2300, according to some embodiments. The user interface 2300 may include a status trend chart 2305. In some embodiments, the user interface 2300 may be generated and/or presented responsive to the technician selecting, via the user interface 2000, a view button that pertains to a status trend chart 2305. In some embodiments, the user interface 2300 may be modified, adjusted, and/or changed. For example, the technician may select icon 2320 to adjust which status information is displayed on the status trend chart 2305. In some embodiments, the trend chart may be downloaded and/or copied. For example, the technician may select download as CSV button 2310 to cause the trend chart to be downloaded. In some embodiments, the trend chart may be displayed in an alternative view. For example, the technician may select view chart in full mode button 2315 to cause the trend chart to be displayed on an updated interface.

In some embodiments, at least one of the user interfaces 2200 and/or the user interface 2300 may include diagnostic information. For example, the user interface 2200 may include information to indicate a temperature trend for a given zone. In some embodiments, the information included in at least one of the user interfaces 2200 and/or 2300 may be utilized by the technician during an initial diagnostic routine.

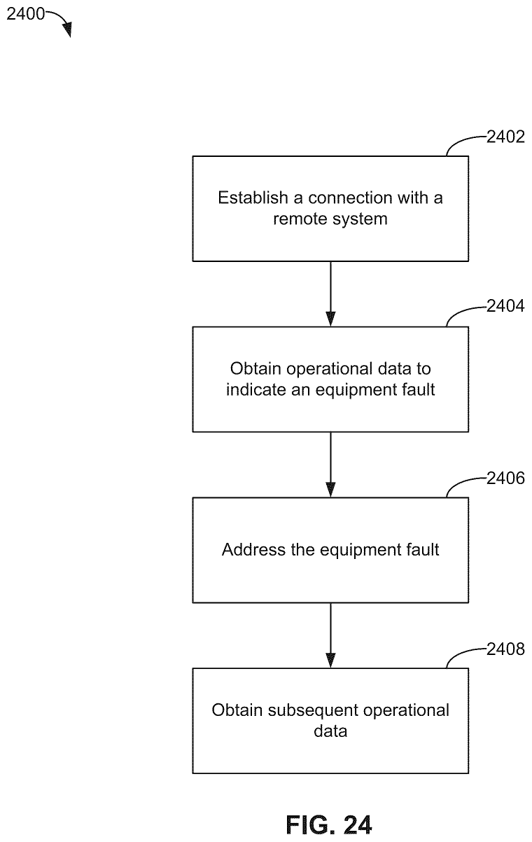

FIG. 24 is a flow diagram of process 2400 for addressing faults in building equipment, according to some embodiments. In some embodiments, at least one step and/or element of the process 2400 may be performed by at least one system, device, and/or component of the system 500. For example, the cloud system 505 may perform at least one step of the process 2400. In some embodiments, at least one step and/or element of the process 2400 may be performed by at least one system, device, and/or component of the system architecture 600.

It should be understood that at least one of the various computing systems and/or computing devices described herein may perform at least one step and/or element of the process 2400. For example, the gateway 515 may perform at least one of the steps of the process 2400. It should also be understood that the memory 530 may receive instructions to cause the processors 525 to execute one or more steps of the process 2400 described herein.

At step 2402, a connection with a remote system may be established. For example, a device that is located remotely and/or separate from a building may be integrated to a Building Automation System (BAS). In some embodiments, the connection may be established on a mobile device. For example, an application may be added to a mobile device, as shown in process 721. In some embodiments, the connection is established via the gateway 515. For example, the mobile device and the BAS may communicate with each other by sending control signals via the gateway 515. Additionally and/or alternatively, the mobile device may directly communicate with one or more devices, pieces of equipment, and/or controllers of the BAS, such that the mobile device may transit one or more signals directly to the components of the BAS.

At step 2404, operational data may be obtained. For example, the cloud system 505 may obtain, via the connection with the remote system, one or more signals containing operational data pertaining to the building equipment. As another example, the cloud system 505 may cause the gateway 515 to transmit operational data to the mobile device. In some embodiments, the operational data may be received by the BAS. For example, the BAS may run a fault detection process on the building equipment. As a result, the operational data may indicate an equipment fault.

At step 2406, the equipment fault may be addressed. For example, the cloud system 505 may access the memory 530 to receive instructions to address the equipment fault. For example, the instructions may cause the processor 525 to produce a control signal to transmit to the building. The cloud system 505 may then transmit the signal, via the gateway 515, to the building. For example, the cloud system 505 may provide a signal to the edge device 610 which may cause the edge device to restart.

At step 2408, subsequent operational data may be obtained. For example, the cloud system 505 may obtain, via the connection with the remote system, one or more signals containing subsequent operational data pertaining to the building equipment. In some embodiments, the subsequent operational data is obtained in response to the equipment fault being addressed at step 2406. For example, the subsequent operational data may provide an indication that the equipment fault has been resolved.

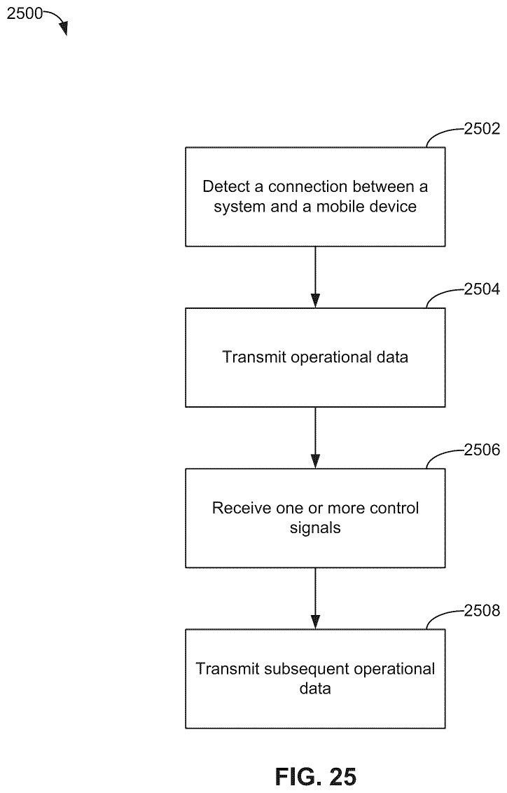

FIG. 25 is a flow diagram of process 2500 for addressing faults in building equipment, according to some embodiments. In some embodiments, at least one step and/or element of the process 2500 may be performed by at least one system, device, and/or component of the system 500. For example, the cloud system 505 may perform at least one step of the process 2500. In some embodiments, at least one step and/or element of the process 2500 may be performed by at least one system, device, and/or component of the system architecture 600.

It should be understood that at least one of the various computing systems and/or computing devices described herein may perform at least one step and/or element of the process 2500. For example, the gateway 515 may perform at least one of the steps of the process 2500. It should also be understood that the memory 530 may receive instructions to cause the processors 525 to execute one or more steps of the process 2500 described herein.

At step 2502, a connection between a system and a mobile device may be detected. For example, the processing circuit 520 may detect a connection between the cloud system 505 and the computing device 510. As another example, the processing circuit 520 may detect that the gateway 515 has established a connection between the cloud system 505 and the computing device 510. In some embodiments, the connection between the system and the mobile device may provide a mobile integration for the mobile device. For example, the mobile device may be granted access to a BMS and/or a BAS maintained and/or supported by the system. Stated otherwise, the connection may provide the mobile device with remote access and/or integration to building systems.

At step 2504, operational data may be transmitted. For example, the processing circuit 520 may transmit operational data associated with the equipment 565. As another example, the processing circuit 520 may provide remote access to one or more databases that store and/or otherwise maintain the operational data. In some embodiments, the processing circuit 520 may transmit the operational data responsive to detecting the connection in step 2502. For example, the processing circuit 520 may transmit the operational data responsive to determining that remote access was established by mobile device. In some embodiments, the operational data may include one or more indicators and/or indications. For example, the operational data may include one or more flags and/or triggers that indicate equipment faults. Stated otherwise, the operation may include indications that one or more devices of building equipment (e.g., the equipment 565) have experienced equipment faults.

At step 2506, one or more control signals may be received. For example, the processing circuit 520 may receive control signals from the computing device 510. As another example, the processing circuit 520 may receive control signals based on one or more interactions with a user interface. In some embodiments, the processing circuit 520 may receive control signals based on the equipment faults indicated in step 2504. For example, the processing circuit 520 may receive control signals associated with the device of building equipment that experienced the equipment fault. As another example, the processing circuit 520 may receive control signals to cause a change in operation of one or more devices. Stated otherwise, the control signals may cause one or more devices (e.g., the equipment 565) to perform one or more actions and/or trigger a change in operation of the devices.

At step 2508, subsequent operational data may be transmitted. For example, the processing circuit 520 may transmit operational data that was collected after and/or that corresponds to activity of the devices after execution of the control signals received in step 2506. As another example, the processing circuit 520 may transmit operational data that is indicative of how one or more devices are performing and/or operating after and/or based on the control signals received in step 2506. In some embodiments, the subsequent operational data may indicate whether the equipment fault has been resolved. For example, the subsequent operational data may indicate that the device has returned to normal and/or expected operation. As another example, the subsequent operational data may indicate that a fault flag and/or fault alert has been cleared (e.g., addressed).

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also, two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

What is claimed is:

1. A mobile device, comprising:
one or more processors; and
a memory coupled to the one or more processors, the memory having a Building Automation System (BAS) application stored thereon, the BAS application including instructions that, when executed by the one or more processors, cause the one or more processors to:
establish a connection with a remote system of a building, the remote system associated with a plurality of devices of building equipment of the building;
obtain, via the connection with the remote system, operational data pertaining to the plurality of devices of building equipment, wherein the operational data comprises an indication that a first device of building equipment of the plurality of devices of building equipment has experienced an equipment fault;
transmit, via the connection with the remote system, one or more control signals to the remote system to address the equipment fault and the one or more control signals causing a change in operation of one or more devices of building equipment of the plurality of devices of building equipment; and
obtain, via the connection with the remote system, subsequent operational data, wherein the subsequent operational data corresponds to operations of the first device of building equipment after transmission of the one or more control signals and indicates whether the equipment fault has been resolved.

2. The mobile device of claim 1, wherein the instructions cause the one or more processors to:
display, via a display of the mobile device, a Graphical User Interface (GUI) including graphical representation of the operational data.

3. The mobile device of claim 2, wherein the instructions further cause the one or more processors to:
determine, responsive to receipt of the subsequent operational data, that the first device of building equipment is still experiencing the equipment fault;
receive, via the GUI, a request to identify one or more second devices of building equipment of the plurality of devices of building equipment that service a first zone of the building, wherein the first device of building equipment also services the first zone of the building; and
establish, via the connection with the remote system, a connection with the one or more second devices of building equipment of the plurality of devices of building equipment.

4. The mobile device of claim 1, wherein the instructions further cause the one or more processors to:
generate, responsive to receipt of an alert associated with the equipment fault, a graphical user interface (GUI) to include a graphical representation of the alert; and
receive, responsive to generation of the GUI, a selection of a selectable element of the GUI which triggers transmission of the one or more control signals to the remote system.

5. The mobile device of claim 4, wherein the instructions further cause the one or more processors to:
update, responsive to the selection of the selectable element, the GUI to include information that indicates a cause of the equipment fault; and
receive, via the GUI, an input that includes resolution of the equipment fault, wherein the input includes information that identifies a performance of one or more actions that resolved the equipment fault.

6. The mobile device of claim 1, wherein the one or more processors establish the connection with the remote system via a gateway, and wherein the gateway is configured to transmit one or more Application Programming Interface (API) messages to a network device to retrieve the operational data.

7. The mobile device of claim 6, wherein the gateway is in communication with a cloud system that stores first information associated with the building in a graph, and wherein the gateway is configured to transmit one or more second API messages to the cloud system to ingest second information associated with the building into the graph.

8. The mobile device of claim 1, wherein transmitting the one or more control signals to the remote system to address the equipment fault comprises:
transmitting, via a network, a first Application Programming Interface (API) message to a cloud system, wherein the first API message includes the one or more control signals; and
causing, responsive to transmission of the first API message, the cloud system to transmit a second API message to the remote system, wherein the second API message includes the one or more control signals, and wherein receipt of the second API message causes the remote system to transmit the one or more control signals to the first device of building equipment.

9. The mobile device of claim 1, wherein the one or more processors are in communication with a computing device, wherein the computing device is configured to (1) determine that the first device of building equipment has experienced the equipment fault and (2) receive an indication to generate a work order to address the equipment fault, and wherein the instructions further cause the one or more processors to:
receive, responsive to generation of the work order, the work order including an indication of the equipment fault; and
provide a graphical user interface (GUI) comprising:
a graphical representation of the work order; and
an indication of one or more actions to implement to address the equipment fault.

10. The mobile device of claim 1, wherein the remote system is configured to:
execute a fault detection or diagnostic (FDD) process to generate the indication that the first device of building equipment of the plurality of devices of building equipment has experienced the equipment fault; and
re-execute, responsive to the change in operation of the one or more devices of building equipment of the plurality of devices of building equipment, the FDD process to determine whether the equipment fault has been addressed.

11. A system comprising one or more memory devices storing instructions thereon that, when executed by one or more processors, cause the one or more processors to:
detect an establishment of a connection between the system and a mobile device;
transmit, responsive to detection of the establishment of the connection, to the mobile device via the connection, operational data pertaining to a plurality of devices of building equipment of a building, wherein the operational data comprises an indication that a first device of building equipment of the plurality of devices of building equipment has experienced an equipment fault;
receive, from the mobile device via the connection, one or more control signals to address the equipment fault and the one or more control signals to cause a change in operation of one or more devices of building equipment of the plurality of devices of building equipment; and
transmit, to the mobile device via the connection, subsequent operational data that corresponds to operation of the first device of building equipment after execution of the one or more control signals and indicates whether the equipment fault has been resolved.

12. The system of claim 11, wherein transmission of the operational data causes the mobile device to:
display a Graphical User Interface (GUI) that includes a graphical representation of the operational data.

13. The system of claim 11, wherein the instructions cause the one or more processors to:
determine, responsive to transmission of the subsequent operational data, that the first device of building equipment is still experiencing the equipment fault;
receive, from the mobile device via the connection, a request to identify one or more second devices of building equipment of the plurality of devices of building equipment that service a first zone of the building, wherein the first device of the building equipment also services the first zone of the building; and
establish a second connection with the one or more second devices of building equipment of the plurality of devices of building equipment.

14. The system of claim 11, wherein the connection with the mobile device is provided via a gateway in communication with the mobile device and the one or more processors, and wherein the gateway is configured to exchange information between the mobile device and the one or more processors via one or more Application Programming Interface (API) messages.

15. The system of claim 11, wherein the instructions cause the one or more processors to:
receive the one or more control signals via an Application Programming Interface (API) message; and
transmit, responsive to receipt of the API message, the one or more control signals to the one or more devices of building equipment to cause the change in the operation of the one or more devices of building equipment.

16. The system of claim 11, wherein the instructions cause the one or more processors to:
determine that the first device of building equipment has experienced the equipment fault;
receive, responsive to determination that the first device of building has experienced the equipment fault, an indication to generate a work order to address the equipment fault; and
provide, responsive to generation of the work order, to the mobile device via the connection, the work order including an indication of the equipment fault.

17. The system of claim 11, wherein the instructions cause the one or more processors to:
execute a fault detection or diagnostic (FDD) process to generate the indication that the first device of building equipment of the plurality of devices of building equipment has experienced the equipment fault; and
re-execute, responsive to the change in operation of the one or more devices of building equipment of the plurality of devices of building equipment, the FDD process to determine whether the equipment fault has been addressed.

18. A method, comprising:
detecting, by one or more processing circuits of a system, an establishment of a connection between the system and a mobile device;
transmitting, by the one or more processing circuits, responsive to detecting the establishment of the connection, to the mobile device via the connection, operational data pertaining to a plurality of devices of building equipment of a building, wherein the operational data comprises an indication that a first device of building equipment of the plurality of devices of building equipment has experienced an equipment fault;
receiving, by the one or more processing circuits, from the mobile device via the connection, one or more control signals to address the equipment fault and the one or more control signals to cause a change in operation of one or more devices of building equipment of the plurality of devices of building equipment; and
transmitting, by the one or more processing circuits, to the mobile device via the connection, subsequent operational data that corresponds to operation of the first device of building equipment after execution of the one or more control signals and indicates whether the equipment fault has been resolved.

19. The method of claim 18, comprising:
determining, by the one or more processing circuits, responsive to transmitting the subsequent operational data, that the first device of building equipment is still experiencing the equipment fault;
receiving, by the one or more processing circuits, from the mobile device via the connection, a request to identify one or more second devices of building equipment of the plurality of devices of building equipment that service a first zone of the building, wherein the first device of the building equipment also services the first zone of the building; and
establishing, by the one or more processing circuits, a second connection with the one or more second devices of building equipment of the plurality of devices of building equipment.

20. The method of claim 18, comprising:
executing, by the one or more processing circuits, a fault detection or diagnostic (FDD) process to generate the indication that the first device of building equipment of the plurality of devices of building equipment has experienced the equipment fault; and
re-executing, by the one or more processing circuits, responsive to the change in operation of the one or more devices of building equipment of the plurality of devices of building equipment, the FDD process to determine whether the equipment fault has been addressed.
